(19) United States
(12) Patent Application Publication
(10) Pub. No.: US 2026/0316991 A1
(43) Pub. Date: Oct. 15, 2026

(54) TRAY WITH DENESTING FEATURES

(71) Applicant: Graphic Packaging International, LLC, Atlanta, GA (US)

(72) Inventor: Lee Nowak, Leicestershire (GB)

(21) Appl. No.: 19/674,958

(22) Filed: May 12, 2026

Related U.S. Application Data
(63) Continuation-in-part of application No. 19/644,023, filed on Apr. 10, 2026.
(60) Provisional application No. 63/788,318, filed on Apr. 14, 2025.

(51) Int. Cl. B65D 5/00; B31B 50/26; B65D 5/32; B65D 5/42; B65D 5/56; B65D 21/02; B31B 100/00; B31B 110/35; B31B 120/40

(52) U.S. Cl. CPC B65D 5/003; B31B 50/262; B65D 5/321; B65D 5/4266; B65D 5/56; B65D 21/0233; B31B 2100/0024; B31B 2110/35; B31B 2120/402

(57) ABSTRACT

A tray for holding one or more products may include an upper construct and a lower construct. The upper construct may include a first plurality of panels comprising a flange panel and a plurality of upper side panels extending from the flange panel. The lower construct may include a second plurality of panels comprising a bottom panel and a plurality of lower side panels forming a sidewall extending at least partially around an interior of the tray. A plurality of denesting features may be formed in the lower construct and may extend in the interior of the tray.

### CROSS-REFERENCE TO RELATED APPLICATION

This application is a continuation-in-part of U.S. Patent Application No. 19/644,023 filed on Apr. 10, 2026; which application claims priority to U.S. Provisional Patent Application No. 63/788,318, filed Apr. 14, 2025..

### INCORPORATION BY REFERENCE

The disclosures of U.S. Patent Application No. 19/644,023, filed on Apr. 10, 2026, and U.S. Provisional Patent Application No. 63/788,318, filed on Apr. 14, 2025, are hereby incorporated by reference for all purposes as if presented herein in their entirety.

### TECHNICAL FIELD

The present disclosure relates to blanks, containers, trays, constructs, and various features and methods for forming a container from a blank. More specifically, the disclosure is generally directed to trays with denesting features.

### BACKGROUND

Trays may be stacked in nested configurations to reduce storage and shipping volume prior to filling. Nested trays may become wedged together or may fit too tightly, making separation of individual trays difficult during automated packaging operations. Existing tray designs may rely on sidewall taper, corner geometry, or flange shape to influence nesting behavior, but such approaches may provide inconsistent stack spacing and may not reliably prevent excessive nesting engagement.

### SUMMARY OF THE DISCLOSURE

According to one aspect of the present disclosure, a tray for holding one or more products may include an upper construct and a lower construct. The upper construct may comprise a first plurality of panels comprising a flange panel and a plurality of upper side panels extending from the flange panel. The lower construct may comprise a second plurality of panels comprising a bottom panel and a plurality of lower side panels forming a sidewall extending at least partially around an interior of the tray. The plurality of lower side panels may include a front panel, a back panel, a first side panel, and a second side panel. A plurality of denesting features may be formed in the lower construct and may extend in the interior of the tray.

In some embodiments, the plurality of denesting features may include a ramp panel foldably connected to the bottom panel at a ramp fold line. The ramp panel may include a free edge opposite the ramp fold line, and the free edge may be at the sidewall. A liner may be configured to be adhered to the ramp panel and the sidewall. In some embodiments, the ramp panel may be a first ramp panel, the ramp fold line may be a first ramp fold line, and the plurality of denesting features may further include a second ramp panel foldably connected to the bottom panel at a second ramp fold line. The second ramp panel may be longitudinally offset from the first ramp panel. The plurality of denesting features may further include a third ramp panel foldably connected to the bottom panel at a third ramp fold line.

According to another aspect of the present disclosure, a combination of blanks for forming a tray for holding one or more products may include an upper blank for forming an upper construct and a lower blank for forming a lower construct. The upper blank may comprise a first plurality of panels comprising a flange panel and a plurality of upper side panels extending from the flange panel. The lower blank may comprise a second plurality of panels comprising a bottom panel and a plurality of lower side panels forming a sidewall extending at least partially around an interior of the tray when the tray is formed from the combination of blanks. The plurality of lower side panels may include a front panel, a back panel, a first side panel, and a second side panel. A plurality of denesting features may be formed in the lower blank and may extend in the interior of the tray when the tray is formed from the combination of blanks.

In some embodiments, the denesting flap may be foldably connected to the respective upper side panel at a respective denesting flap fold line and the denesting flap fold line may be vertically offset from the plurality of denesting features may include a ramp panel foldably connected to the bottom panel at a ramp fold line. The ramp panel may include a free edge opposite the ramp fold line, and the free edge may be at the sidewall when the tray is formed from the combination of blanks. A liner may be configured to be adhered to the ramp panel and the sidewall when the tray is formed from the combination of blanks. In some embodiments, the ramp panel may be a first ramp panel, the ramp fold line may be a first ramp fold line, and the plurality of denesting features may further include a second ramp panel foldably connected to the bottom panel at a second ramp fold line. The second ramp panel may be longitudinally offset from the first ramp panel. The plurality of denesting features may further include a third ramp panel foldably connected to the bottom panel at a third ramp fold line.

According to another aspect of the present disclosure, a method of forming a tray for holding one or more products may include providing an upper construct comprising a first plurality of panels comprising a flange panel and a plurality of upper side panels extending from the flange panel. The method may include providing a lower construct comprising a second plurality of panels comprising a bottom panel and a plurality of lower side panels forming a sidewall extending at least partially around an interior of the tray. The plurality of lower side panels may include a front panel, a back panel, a first side panel, and a second side panel. The method may include forming a plurality of denesting features in the lower construct and extending in the interior of the tray.

In some embodiments, the plurality of denesting features may include a ramp panel foldably connected to the bottom panel at a ramp fold line. The ramp panel may include a free edge opposite the ramp fold line, and the free edge may be at the sidewall. The method may further comprise adhering a liner to the ramp panel and the sidewall. In some embodiments, the ramp panel may be a first ramp panel, the ramp fold line may be a first ramp fold line, and the plurality of denesting features may further include a second ramp panel foldably connected to the bottom panel at a second ramp fold line. The second ramp panel may be longitudinally offset from the first ramp panel. The plurality of denesting features may further include a third ramp panel foldably connected to the bottom panel at a third ramp fold line.

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of a lower blank for forming a tray according to an embodiment of the disclosure.

FIG. 2 is a plan view of an upper blank for forming a tray according to an embodiment of the disclosure.

FIG. 3 is an upper perspective view of an upper construct formed from the blank of FIG. 2.

FIG. 4 is a perspective view of a lower construct formed from the blank of FIG. 1 according to an embodiment of the disclosure.

FIG. 5 is an upper perspective view of a tray formed from the blanks of FIGS. 1 and 2 according to an embodiment of the disclosure.

FIG. 6 is another upper perspective view of the tray shown in FIG. 5, according to an embodiment of the disclosure.

FIG. 7 is an upper perspective view of the tray shown in FIG. 5 with a lidding film applied to a flange of the tray.

FIG. 8 is an additional upper perspective view of the tray shown in FIG. 5, according to an embodiment of the disclosure.

FIG. 9 is an elevated side view of the tray shown in FIG. 5, according to an embodiment of the disclosure.

FIG. 10 is a top view of the tray shown in FIG. 5, according to an embodiment of the disclosure.

FIG. 11 is a perspective bottom view of the tray shown in FIG. 5, according to an embodiment of the disclosure.

FIG. 12 is another perspective bottom view of the tray shown in FIG. 5, according to an embodiment of the disclosure.

FIG. 13 is a bottom view of the tray shown in FIG. 5, according to an embodiment of the disclosure.

FIG. 14 is an exploded perspective view of a portion of the tray shown in FIG. 5, according to an embodiment of the disclosure.

FIG. 15 is an exploded elevated side view of a portion of the tray shown in FIG. 5, according to an embodiment of the disclosure.

FIG. 16 is another exploded perspective view of a portion of the tray shown in FIG. 5, according to an embodiment of the disclosure.

FIG. 17 is an upper perspective view of a first stack of trays according to an embodiment of the disclosure.

FIG. 18 is a side view of the first stack of trays shown in FIG. 17, according to an embodiment of the disclosure.

FIG. 19 is an elevated side view of the first stack of trays shown in FIG. 17, according to an embodiment of the disclosure.

FIG. 20 is a cross-sectional view of a second stack of trays according to an embodiment of the disclosure.

FIG. 21 is a schematic view of an apparatus for processing blanks and/or trays that can be used with embodiments of the present disclosure.

FIG. 22 is an upper perspective view of a tray formed according to a second embodiment of the disclosure.

FIG. 23 is an exploded perspective view of a portion of the tray shown in FIG. 22, according to the second embodiment of the disclosure.

FIG. 24 is a perspective bottom view of the tray shown in FIG. 22, according to the second embodiment of the disclosure.

FIG. 25 is a cross-sectional view of a stack of trays according to the second embodiment of the disclosure.

FIG. 26 is a plan view of a lower blank for forming the tray shown in FIG. 22, according to the second embodiment of the disclosure.

FIG. 27 is a plan view of an upper blank for forming the tray shown in FIG. 22, according to the second embodiment of the disclosure.

FIG. 28 is an upper perspective view of a tray formed according to a third embodiment of the disclosure.

FIG. 29 is a top view of the tray formed according to a third embodiment of the disclosure.

FIG. 30 is a perspective bottom view of the tray shown in FIG. 28, according to the third embodiment of the disclosure.

FIG. 31 is a cross-sectional view of a stack of trays according to the third embodiment of the disclosure.

FIG. 32 is a plan view of a upper blank for forming the tray shown in FIG. 28, according to the third embodiment of the disclosure.

FIG. 33 is a plan view of an lower blank for forming the tray shown in FIG. 28, according to the third embodiment of the disclosure.

FIG. 34 is a plan view of a upper blank for forming a tray according to a fourth embodiment of the disclosure.

Corresponding parts are designated by corresponding reference numbers throughout the drawings.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques disclosed herein relate generally to trays for holding one or more products. More specifically, techniques disclosed herein relate to trays formed from a combination of blanks including an upper blank for forming an upper construct and a lower blank for forming a lower construct, wherein the upper construct or the lower construct may include denesting features that maintain a desired spacing between nested trays and facilitate separation of stacked trays. Various embodiments may be described herein, including trays, combinations of blanks for forming such trays, and methods of forming trays, and the like.

The present disclosure relates to a tray for holding one or more products, such as food items, where the tray is formed from two paperboard blanks that are folded and assembled together. The first blank forms a lower construct that provides the bottom and sidewalls of the tray. The second blank forms an upper construct that provides a flange extending around the top of the tray and a set of side panels that fold down along the interior of the sidewalls to reinforce the tray structure.

The tray can include a set of denesting features formed by either the upper construct or the lower construct. Each denesting feature may include a flap that folds inwardly from one of the upper side panels and extends down toward the bottom of the tray at an oblique angle. Small tabs extend from each flap to further engage the bottom of the tray. Additionally, or alternatively, the denesting features may include a ramp panel that extends obliquely upward from a bottom panel to a side panel. When multiple trays are stacked together in a nested arrangement, these flaps and tabs or ramp panels may bear against the bottom of the tray above, maintaining a controlled gap between nested trays and preventing the trays from wedging too tightly together.

The controlled spacing provided by the denesting features allows stacked trays to be separated easily, whether by hand or by automated packaging equipment. The tray may also be provided with a liner applied to the interior surfaces and a lidding film sealed to the flange to protect the contents. The tray construction is compatible with high-speed forming and lining operations and may be used in a variety of food packaging applications.

Various aspects of the disclosure may be understood further by referring to the figures. For purposes of simplicity, like numerals may be used to describe like features. It will be understood that where a plurality of similar features are depicted, not all of such features necessarily are labeled on each figure. It also will be understood that the various components used to form the constructs may be interchanged. Thus, while only certain combinations are illustrated herein, numerous other combinations and configurations are contemplated hereby.

The present disclosure relates generally to various aspects of containers, constructs, trays, materials, packages, elements, and articles, and methods of making such containers, constructs, trays, materials, packages, elements, and articles. Although several different aspects, implementations, and embodiments are disclosed, numerous interrelationships between, combinations thereof, and modifications of the various aspects, implementations, and embodiments are contemplated hereby. In one illustrated embodiment, the present disclosure relates to forming a container or tray for holding food items or various other articles. However, in other embodiments, the container or tray can be used to form other non-food containing articles or may be used for heating or cooking.

Trays described herein can be used for holding one or more articles such as food products, e.g., portioned retail food products that can include one or more of cookies, crackers, cakes, pastries, candies, nuts, popcorn, trail mix, gum, etc. In some embodiments, the articles can include frozen or non-frozen food products that can be provided in discrete portions, for example, chicken nuggets, French fries, onion rings, mozzarella sticks, chips, popcorn, other finger foods, etc. In embodiments, other types of articles that can include food products and/or non-food products can be placed in the tray for service to a customer. In some embodiments, such products can be contained in additional packaging and then placed in the tray. The tray could be otherwise shaped and arranged and could be used to hold other products and/or articles in similar or different environments without departing from the disclosure.

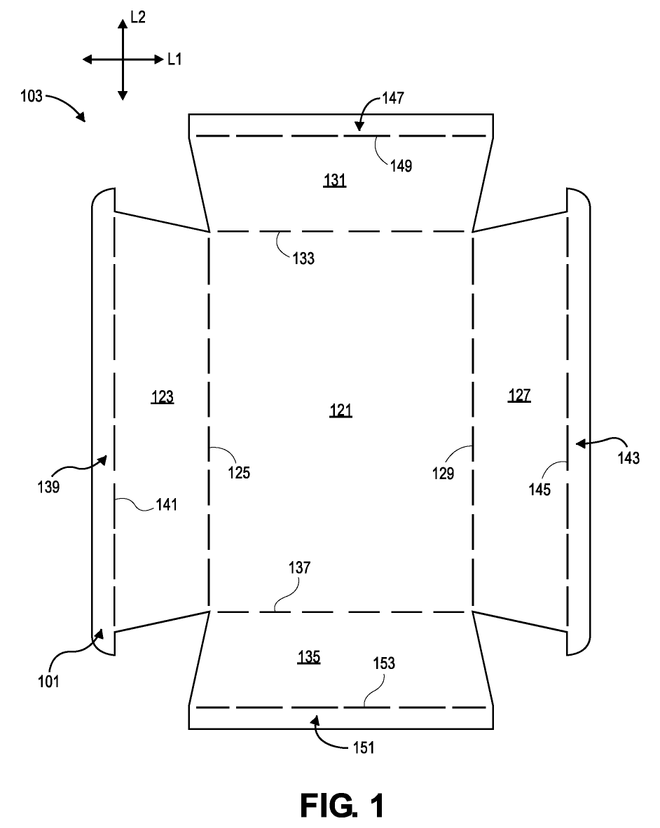

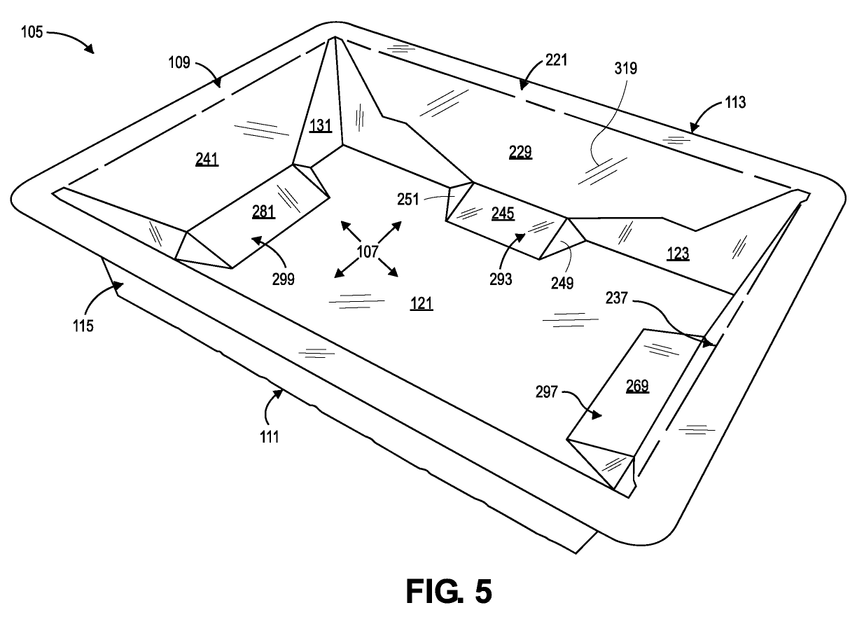

FIG. 1 illustrates an exterior surface 101 of a first blank or lower blank 103 for at least partially forming a tray 105 (see, e.g., FIG. 5) or other container according to embodiments of the disclosure. In some embodiments, the lower blank 103 can form a first construct or lower construct 111 of such tray 105. In one embodiment, the lower blank 103 comprises paperboard (e.g., solid bleached sulphate folding boxboard), or other suitable material that can be recyclable and/or suitable for use in an oven (not shown).

The lower blank 103 can be formed from a single ply of material, such as but not limited to paperboard, cardboard, paper, a polymeric sheet, and/or a laminate that includes more than one layer. In some embodiments, the lower blank 103 can include a microwave interactive layer such as is common in MicroRite® containers available from Graphic Packaging International of Atlanta, GA. The microwave interactive layer can be commonly referred to as, or can have as one of its components, a susceptor, a foil, a microwave shield, or any other term or component that refers to a layer of material suitable for shielding microwave energy and/or causing heating in a microwave oven.

As shown in FIG. 1, the lower blank 103 has a lateral direction L1 and a longitudinal direction L2. It will be understood that the axes L1, L2 could be transposed or otherwise oriented without departing from the disclosure. In the illustrated embodiment, the lower blank 103 and lower construct 111/tray 105 formed therefrom includes a plurality of panels comprising a bottom panel 121, a first side panel 123 foldably connected to the bottom panel 121 at a longitudinal fold line 125, a second side panel 127 foldably connected to the bottom panel 121 at a longitudinal fold line 129, a back panel 131 foldably connected to the bottom panel 121 at a lateral fold line 133, and a front panel 135 foldably connected to the bottom panel 121 at a lateral fold line 137. The side panels 123, 127, the back panel 131, and the front panel 135 can be considered bottom side panels of the lower blank 103/lower construct 111/tray 105.

A plurality of end flaps can be foldably connected to a respective panel of the plurality of panels of the lower blank 103 and lower construct 111/tray 105 formed therefrom. In the illustrated embodiment, a top end flap 139 can be foldably connected to the first side panel 123 at a longitudinal fold line 141, a top end flap 143 can be foldably connected to the second side panel 127 at a longitudinal fold line 145, a top end flap 147 can be foldably connected to the back panel 131 at a lateral fold line 149, and a top end flap 151 can be foldably connected to the front panel 135 at a lateral fold line 153.

As described further herein, the plurality of end flaps 139, 143, 147, 151 can be arranged to at least partially form a rim or flange 109 (see, e.g., FIG. 5) of the tray 105 when the tray 105 is formed.

It will be understood that one or more of the panels, end flaps, or other portions of the lower blank 103 and lower construct 111 formed therefrom can have a different configuration without departing from the disclosure.

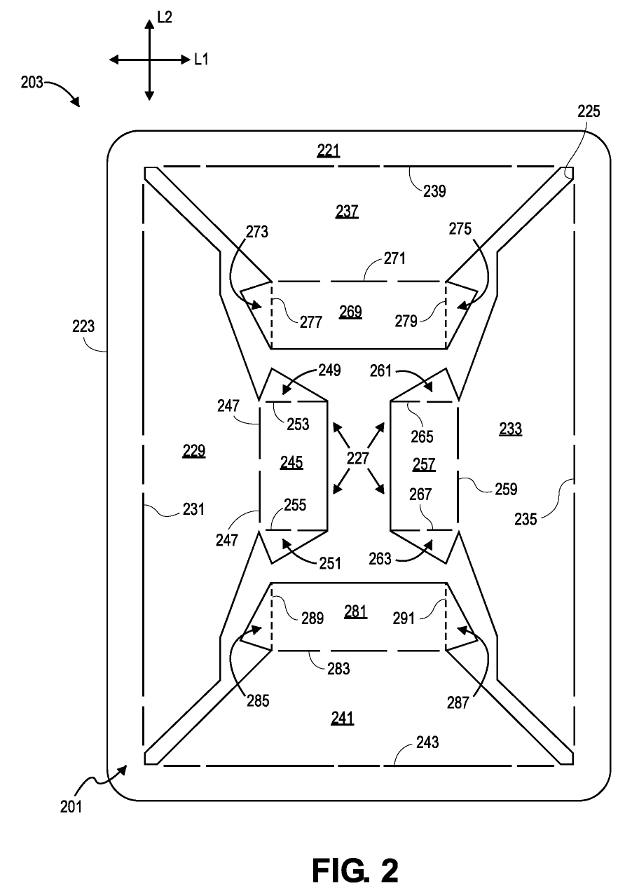

Turning now to FIG. 2, the exterior surface 201 of the second blank or upper blank 203 for at least partially forming the tray 105 is illustrated according to an embodiment of the disclosure. The upper blank 203 can cooperate with the lower blank 103 to at least partially form the tray 105 such that the tray 105 can be formed from the combination of blanks 103, 203. As described further herein, the upper blank 203 can form a second construct or upper construct 113 of the tray 105. In some embodiments, the upper blank 203 can be formed of a material similar to or the same as that of the lower blank 103, e.g., paperboard or paperboard layered with one or more other materials.

As shown, the upper blank 203 has the lateral axis L1 and the longitudinal axis L2, and can include a plurality of panels that includes a top panel or rim panel or flange panel 221. The flange panel 221, as shown, can at least partially define an outer free edge 223 and an inner edge 225 that at least partially circumscribes and at least partially defines an opening 227.

The plurality of panels of the upper blank 203 can also include a first side attachment panel 229 foldably connected to the inner edge 225 of the flange panel 221 at a longitudinal fold line 231 and positioned extending into the opening 227, a second side attachment panel 233 foldably connected to the inner edge 225 of the flange panel 221 at a longitudinal fold line 235 and positioned extending into the opening 227, a front side attachment panel 237 foldably connected to the inner edge 225 of the flange panel 221 at a lateral fold line 239 and positioned extending into the opening 22. and a back side attachment panel 241 foldably connected to the inner edge 225 of the flange panel 221 at a lateral fold line 243 and positioned extending into the opening 227. The side attachment panels 229, 233, 237, 241 can be considered upper side panels of the upper blank 203/upper construct 113/tray 105.

The upper blank 203 and the upper construct 113 formed therefrom can further include denesting features for maintaining a desired spacing between stacked or nested trays 105, between other trays or containers nested within a given tray 105 and/or facilitating disengagement of a stacked arrangement of trays including the tray 105.

In the illustrated embodiment, the upper blank 203 and the upper construct 113 formed therefrom can include a first denesting flap 245 foldably connected to the first side attachment panel 229 at a longitudinal fold line 247. A first pair of denesting tabs 249, 251 can be foldably connected to the first denesting flap 245 at respective lateral fold lines 253, 255.

Similarly, a second denesting flap 257 can be foldably connected to the second side attachment panel 233 at a longitudinal fold line 259. A second pair of denesting tabs 261, 263 can be foldably connected to the second denesting flap 257 at respective lateral fold lines 265, 267.

A third denesting flap 269 can be foldably connected to the front side attachment panel 237 at a lateral fold line 271. A third pair of denesting tabs 273, 275 can be foldably connected to the third denesting flap 269 at respective longitudinal fold lines 277, 279.

As also shown, a fourth denesting flap 281 can be foldably connected to the back side attachment panel 241 at a lateral fold line 283. A fourth pair of denesting tabs 285, 287 can be foldably connected to the fourth denesting flap 281 at respective longitudinal fold lines 289, 291.

In this regard, the denesting flaps 245, 257, 269, 281 can be foldably connected to a respective panel of the plurality of panels of the upper blank 203/upper construct 113/tray 105, and the denesting tabs 249, 251, 261, 263, 273, 275, 285, 287 can be foldably connected to a respective denesting flap of the plurality of denesting flaps. In some embodiments, one or more of the denesting flaps 245, 257, 269, 281 and the denesting tabs 249, 251, 261, 263, 273, 275, 285, 287 can be considered a plurality of end flaps of the upper blank 203/upper construct 113/tray 105. In some embodiments, the fold lines 247, 259, 271, 283 at which the respective denesting flaps 245, 257, 269, 281 are foldably connected to the respective upper side panels 229, 233, 237, 241 can be vertically offset from the bottom panel 121 when the tray 105 is formed.

It will be understood that one or more of the panels, end flaps, or other portions of the upper blank 203 and upper construct 113 formed therefrom can have a different configuration without departing from the disclosure. For example, the illustrated embodiment shows four denesting flaps, however other embodiments may have one, two, five or more denesting flaps.

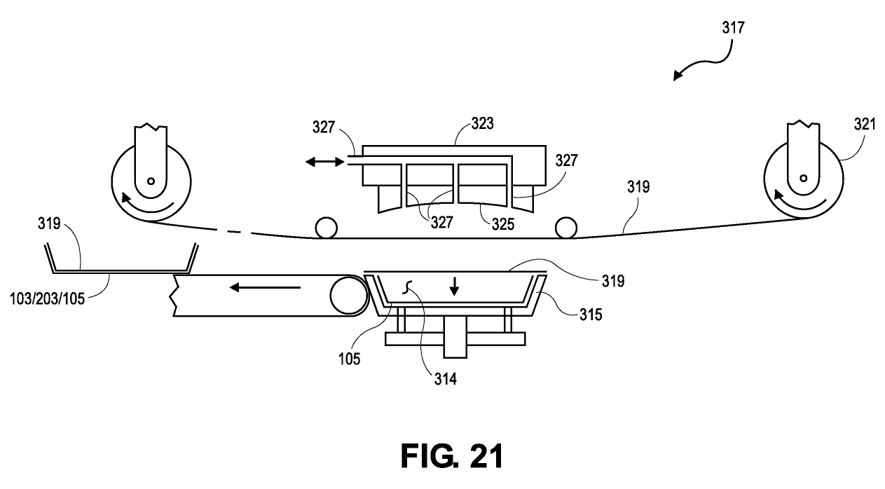

The blanks 103, 203 can, in some embodiments, be provided with a film sheet or liner 319 (see, e.g., FIGS. 5 or 21) that comprises a plastic layer such as polyethylene, a polyethylene terephthalate (PET) material, or any other thermoplastic material, or a bioplastic, such as vegetable oil or starch based plastics. In one embodiment, such liner 319 can comprise polyethylene that can be softened and fused to the blanks 103, 203. In an alternative embodiment, the liner 319 for being attached to the lower blank 103 can comprise PET or a similar material that is at least partially attached to the lower blank 103 by a heat seal layer (e.g., a thermoformable sealant grade transparent polyester packaging film), such as Mylar® XMPOL12 available from DuPont Teijin Films U.S. Limited Partnership of Hopewell, Virginia, or any suitable thermoformable sealant or adhesive, any suitable heat or pressure activated adhesive, or any other suitable material), wherein a PET liner can be more suitable for uses that require heating of the container in an oven.

Such a liner 319 can be at least partially attached to the blanks 103, 203 for being positioned in contact with one or more food products held in the tray 105 (e.g., during heating). In one embodiment, after heating the food product, the blanks 103, 203 and the accompanying liner 319 can be separated to allow both the blanks 103, 203 and the liner 319 to be disposed of (e.g., recycled, renewed, reused, etc.) separately. Optionally, the blanks 103, 203 can be provided separately from or without the liner 319.

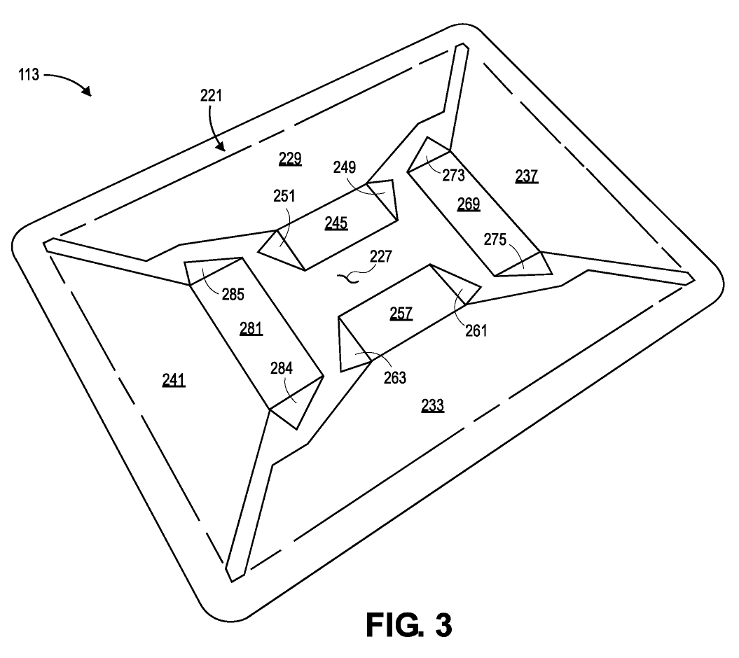

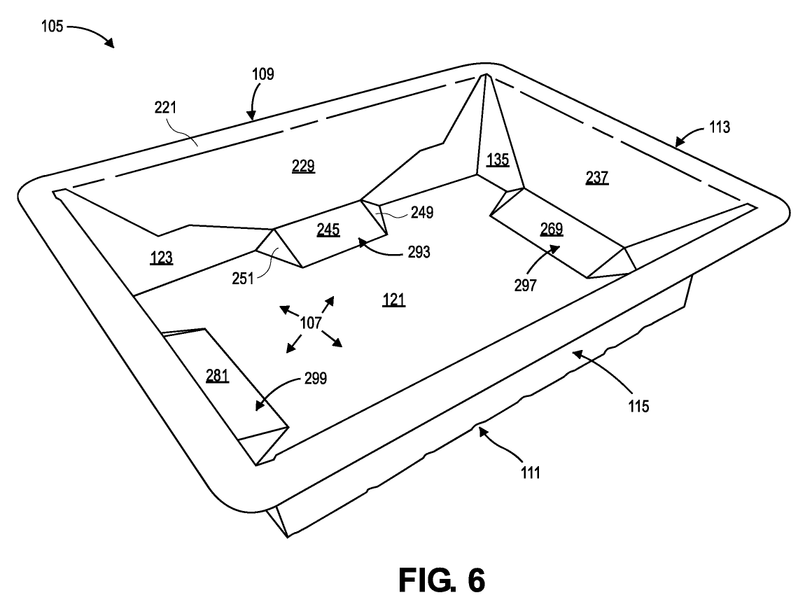

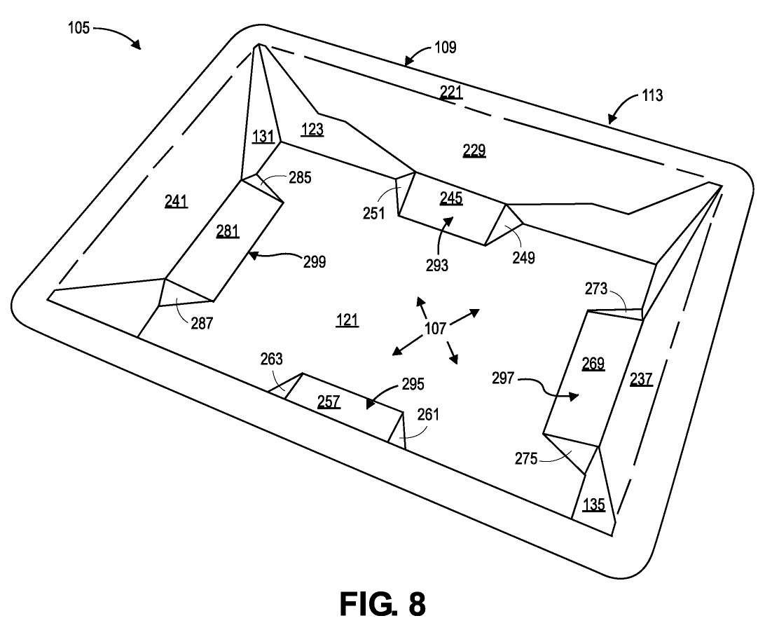

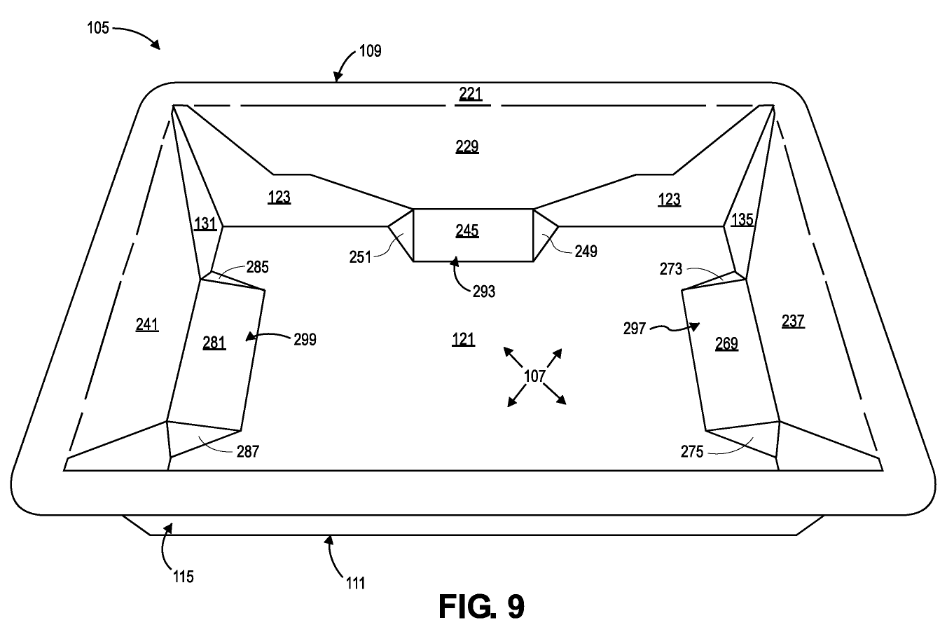

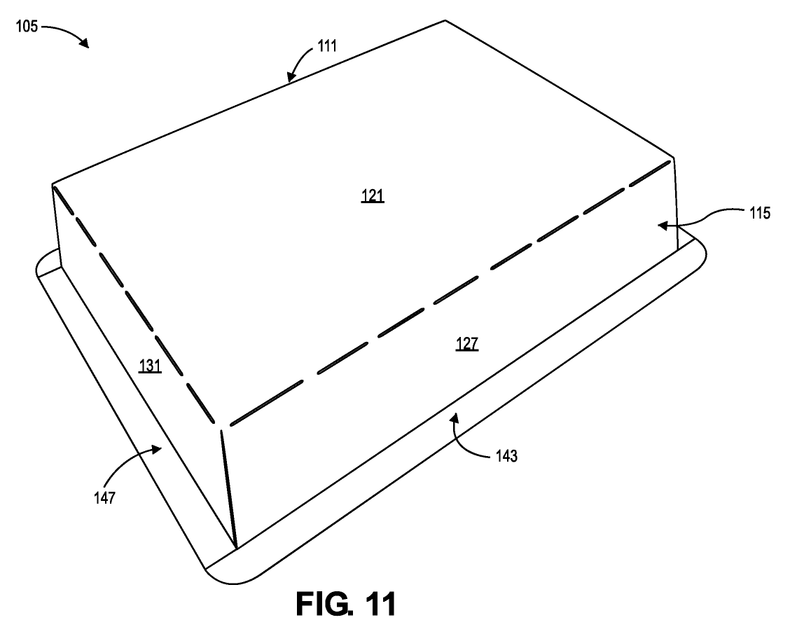

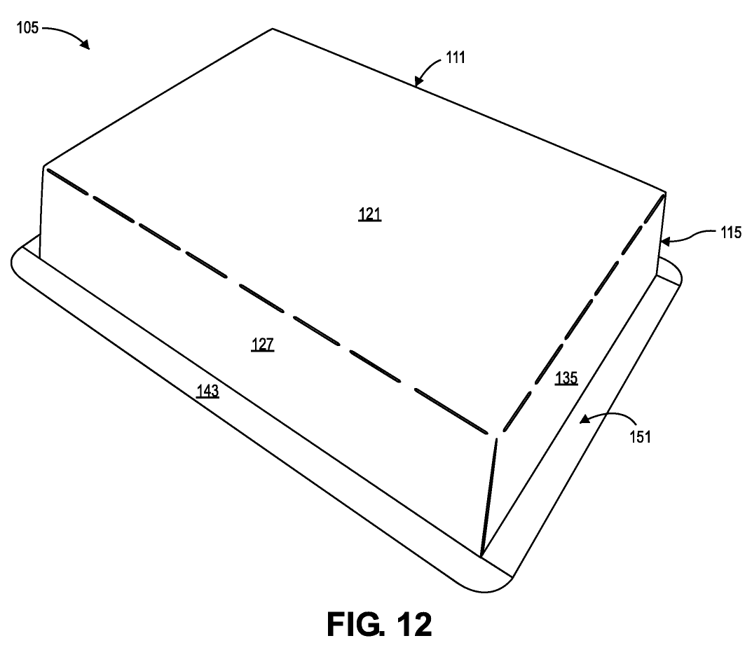

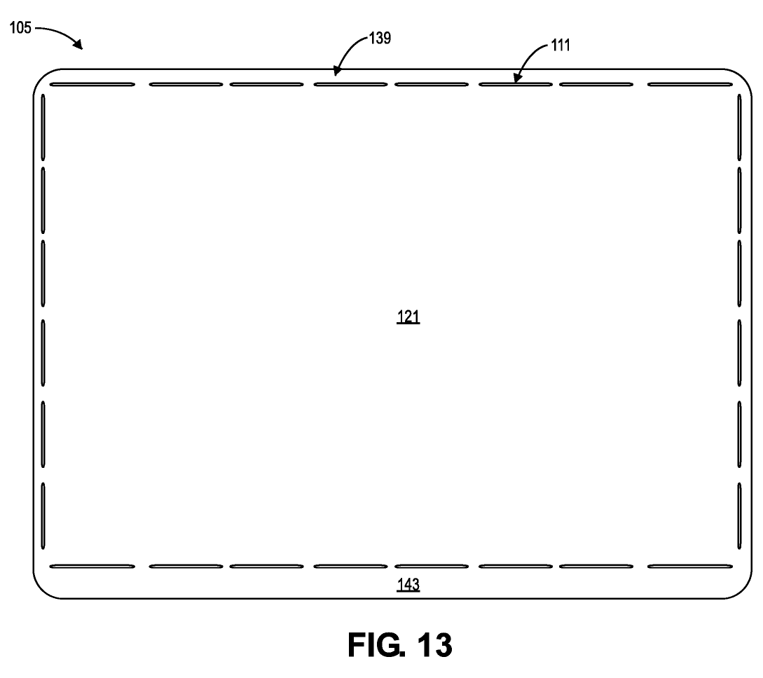

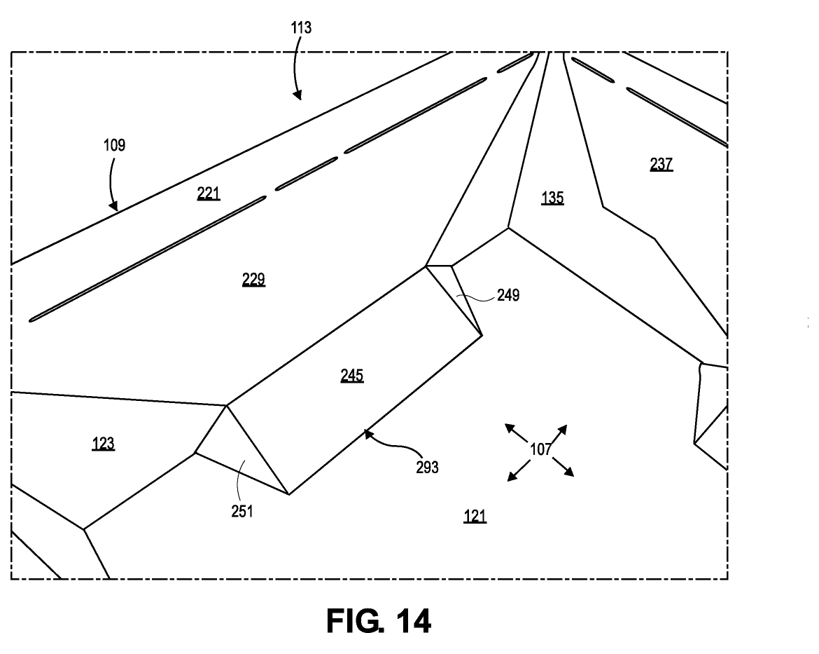

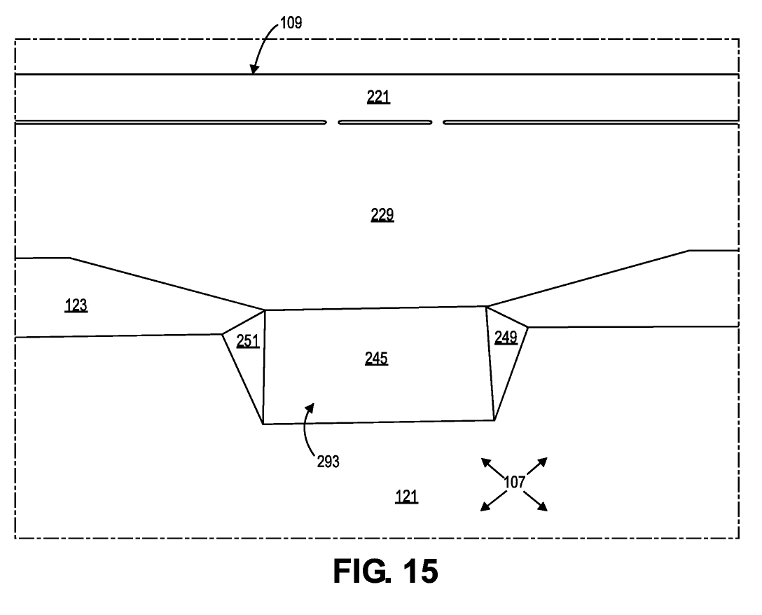

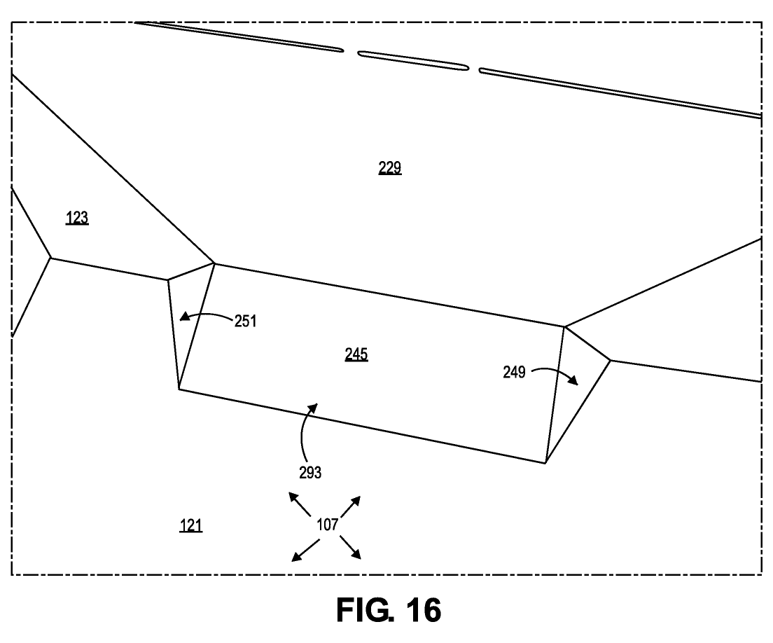

With additional reference to FIGS. 3-17, formation of the tray 105 from the combination of the blanks 103, 203 will be described according to an embodiment of the disclosure.

FIG. 3 is an upper perspective view of the upper construct 113 formed from the upper blank 203. As shown, the upper construct 113 includes the flange panel 221 defining the outer free edge 223 and the inner edge 225 circumscribing the opening 227. The first side attachment panel 229, the second side attachment panel 233, the front side attachment panel 237, and the back side attachment panel 241 can each be folded downwardly at the respective fold lines 231, 235, 239, 243 relative to the flange panel 221 and can extend into the opening 227.

The denesting flaps 245, 257, 269, 281 can each be folded inwardly at the respective fold lines 247, 259, 271, 283 relative to the respective side attachment panels 229, 233, 237, 241. The denesting tabs 249, 251, 261, 263, 273, 275, 285, 287 can each be folded at the respective fold lines 253, 255, 265, 267, 277, 279, 289, 291 to extend obliquely away from the respective denesting flaps 245, 257, 269, 281. In some embodiments, the denesting flaps 245, 257, 269, 281 and the respective denesting tabs can be arranged to form denesting features in the interior 107 of the tray 105 upon assembly of the upper construct 113 with the lower construct 111.

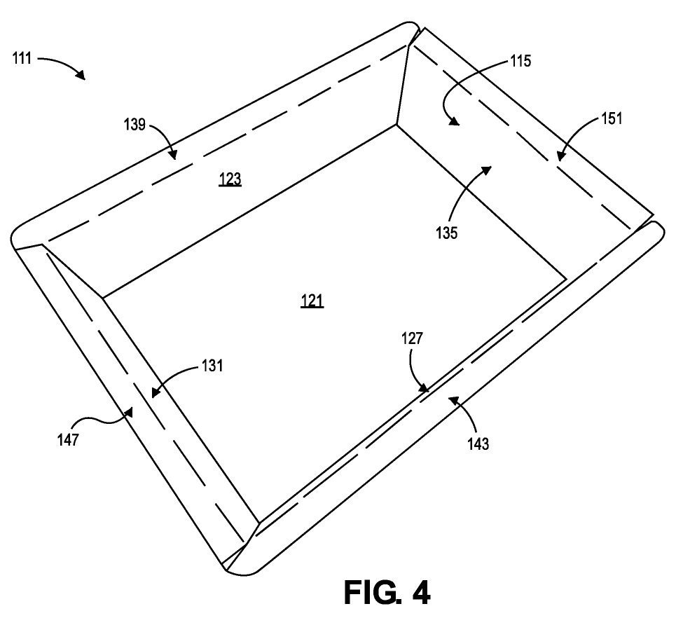

FIG. 4 is an upper perspective view of the lower construct 111 formed from the lower blank 103. To form the lower construct 111, the lower blank 103 can be positioned with the interior thereof (e.g., planarly opposite the exterior surface 101) facing upwardly, and with the exterior surface 101 supported on a supporting surface, e.g., table, conveyor, bedplate, etc. The panels 123, 127, 131, 135 can be at least partially raised relative to the bottom panel 121 via at least partial folding at the respective fold lines 125, 129, 133, 137 such that the panels 123, 127, 131, 135 can be obliquely arranged relative to the bottom panel 121.

It will be understood that, in some embodiments, one or more of the panels 123, 127, 131, 135 can be positioned in a generally perpendicularly upright orientation relative to the bottom panel 121.

The plurality of end flaps 139, 143, 147, 151 can be folded at the respective fold lines 141, 145, 149, 153 into a generally outward arrangement, e.g., extending away from the interior 107 of the tray 105/lower construct 111 and in a generally spaced and parallel arrangement with respect to the bottom panel 121 and so as to extend away from registration therewith.

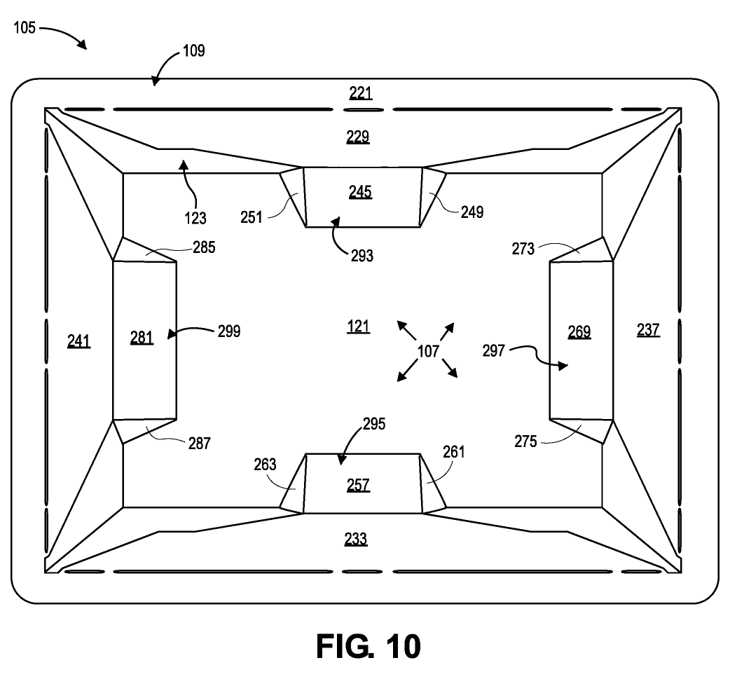

With continued reference to FIGS. 5-16, and referring in particular to FIGS. 5 and 10, the upper blank 203 can be placed above the lower construct 111, with the exterior surface 201 facing upwardly and the interior surface thereof facing downwardly. The flange panel 221 can be positioned over the end flaps 139, 143, 147, 151 such that the interior surfaces of the end flaps 139, 143, 147, 151 are positioned in at least partial face-to-face contact with the interior surface of the flange panel 221 to form the flange 109 of the tray 105.

The first side attachment panel 229 can be folded at least partially downwardly at the fold line 231 into at least partial face-to-face contact with the first side panel 123 and the second side attachment panel 233 can be folded at the fold line 235 into at least partial face-to-face contact with the second side panel 127.

The front side attachment panel 237 can be folded at least partially downwardly at the fold line 239 into at least partial face-to-face contact with a respective portions of the front panel 135. Similarly, the back side attachment panel 241 can be folded at least partially downwardly at the fold line 243 into at least partial face-to-face contact with respective portions of the back panel 131.

Furthermore, the first denesting flap 245 can be at least partially folded at the fold line 247 into a generally oblique arrangement with the first side attachment panel 229, and the first pair of denesting tabs 249, 251 can be at least partially folded at the respective fold lines 253, 255 to extend obliquely away from the first denesting flap 245. In some embodiments, the fold line 247 can be vertically offset from the bottom panel 121 when the tray 105 is formed. In this regard, the first denesting flap 245 can extend from the fold line 247 to a distal end thereof, and one or more of the distal end of the first denesting flap 245, the denesting tab 249, and the denesting tab 251 can contact the bottom panel 121. The arrangement of the first denesting flap 245 and the first pair of denesting tabs 249, 251 can form a first denesting feature 293 in the interior 107 of the tray 105.

Similarly, the second denesting flap 257 can be at least partially folded at the fold line 259 into a generally oblique arrangement with the second side attachment panel 233, and the second pair of denesting tabs 261, 263 can be at least partially folded at the respective fold lines 265, 267 to extend obliquely away from the second denesting flap 257. In this regard, the second denesting flap 257 can extend from the fold line 259 to a distal end thereof, and one or more of the distal end of the second denesting flap 257, the denesting tab 261, and the denesting tab 263 can contact the bottom panel 121. The arrangement of the second denesting flap 257 and the second pair of denesting tabs 261, 263 can form a second denesting feature 295 in the interior 107 of the tray 105.

The third denesting flap 269 can be at least partially folded at the fold line 271 into a generally oblique arrangement with the front side attachment panel 237, and the third pair of denesting tabs 273, 275 can be at least partially folded at the respective fold lines 277, 279 to extend obliquely away from the third denesting flap 269. In this regard, the third denesting flap 269 can extend from the fold line 271 to a distal end thereof, and one or more of the distal end of the third denesting flap 269, the denesting tab 273, and the denesting tab 275 can contact the bottom panel 121. The arrangement of the third denesting flap 269 and the third pair of denesting tabs 273, 275 can form a third denesting feature 297 in the interior 107 of the tray 105.

As also shown, the fourth denesting flap 281 can be at least partially folded at the fold line 283 into a generally oblique arrangement with the back side attachment panel 241, and the fourth pair of denesting tabs 285, 287 can be at least partially folded at the respective fold lines 289, 291 to extend obliquely away from the fourth denesting flap 281. In this regard, the fourth denesting flap 281 can extend from the fold line 283 to a distal end thereof, and one or more of the distal end of the fourth denesting flap 281, the denesting tab 285, and the denesting tab 287 can contact the bottom panel 121. The arrangement of the fourth denesting flap 281 and the fourth pair of denesting tabs 285, 287 can form a fourth denesting feature 299 in the interior 107 of the tray 105.

The aforementioned arrangement of the tray 105 can be maintained with one or more applications of an adhesive such as glue.

In such an arrangement, the panels 121, 123, 127, 131, 135 can be positioned extending at least partially around an interior 107 of the tray 105/lower construct 111, with at least the panels 123, 127, 131, 135 forming a sidewall 115 of the tray 105/lower construct 111.

The side attachment panels 229, 233, 237, 241 can provide reinforcement to the sidewall 115, and, in some embodiments, one or more of the side attachment panels 229, 233, 237, 241 can form a portion of the sidewall 115.

For example, one or more of the side attachment panels 229, 233, 237, 241 can provide a respective portion of the sidewall 115 with a resistance to deformation, e.g., bending, bowing, buckling, creasing, etc., by providing an additional ply of material therealong.

It will be understood that, in some embodiments, the lower construct 111 can be formed from the lower blank 103 upon at least partial formation of the sidewall 115 and that the upper construct 113 can be formed from the upper blank 203 upon movement of the side attachment panels 229, 233, 237, 241 relative to the flange panel 221. In some embodiments, the upper construct 113 can be formed upon attachment of a respective side attachment panel 229, 233, 237, 241 to a respective panel of the plurality of panels of the lower blank 103/lower construct 111.

In this regard, the flange 109 of the tray 105 is positioned in a generally outward arrangement, e.g., extending away from the interior 107 of the tray 105/lower construct 111, and away from the sidewall 115, and in a generally spaced and parallel arrangement with respect to the bottom panel 121 and so as to extend away from registration therewith.

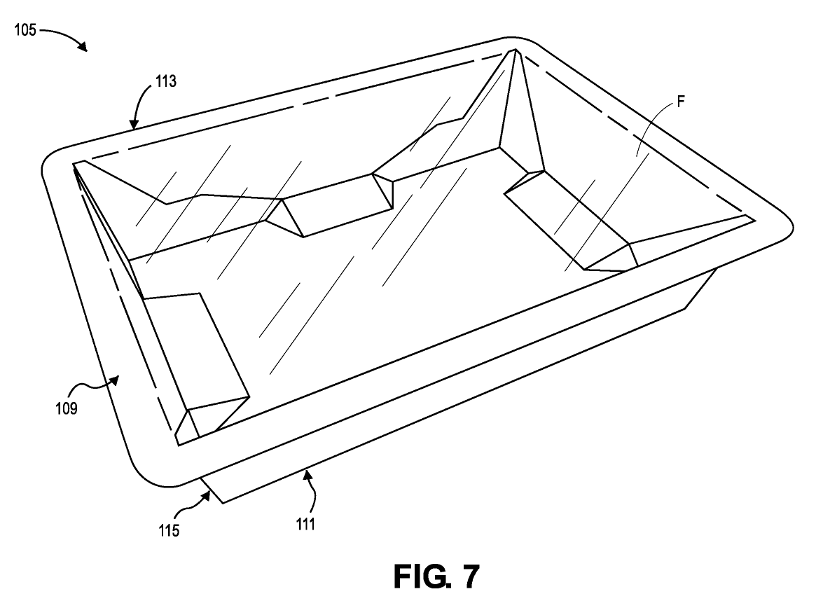

As shown in FIG. 7, in some embodiments, a lid/lid structure such as a lidding film F can comprise packaging film that is a thin plastic layer used to preserve and protect one or more articles contained in the tray 105 and can be removably attached to the flange 109 of the tray 105, e.g., defined by a portion of the flange panel 221. Such a lidding film F can cover the flange 109 of the tray 105 so as to cover the interior 107 of the tray 105. In some embodiments, a hermetic seal of the interior 107 of the tray 105 can be achieved by such engagement by a lidding film F.

Any suitable plastic film, such as polyethylene, polypropylene, polyethylene terephthalate, polyvinylchloride, polyamide, and ethylene vinyl alcohol, or other suitable material, can be used for forming the lidding film F that is sealed against the sealing surface of the flange 109/flange panel 221. Further, adhesives can be used between the lidding film F and the sealing surface of the flange/central panel without departing from the disclosure.

As described above, in embodiments, a liner 319 can be applied to at least the interior 107 of the tray 105, and can overlie seams/points of intersection between the respective panels, e.g., such that the tray 105 has leak-resistant properties. Such liner 319 can be separably connected to one or more surfaces of the tray 105 along the interior 107 thereof, for example, so that the liner 319 and tray 105 can be separately disposed of after use.

In this regard, the separable arrangement of the tray 105 and the liner 319 can facilitate the separate reuse, renewal, recycling, etc. of the paperboard material that forms the tray 105 and the polymeric material that forms the liner 319, without commingling thereof. In some embodiments, a tray 105 can be provided with both the lidding film F and the liner 319.

In an embodiment shown in FIG. 21, the blanks 103, 203/tray 105 or a folded configuration thereof can be placed on a lower die 315 of a system 317 and a sheet of material that forms the liner 319 (e.g., a polyethylene or PET web) can be fed from a supply roller 321 above the blanks 103, 203/tray 105. The lower die 315 can include a cavity 314 for receiving the blanks 103, 203/tray 105. An upper die 323 has a heater plate surface 325 with a PTFE coating, (such as, e.g., a Teflon® coating). Alternatively, the heater plate surface 325 could have a coating of any suitable material or the coating could be omitted.

As shown in FIG. 21, the upper die 323 can include a plurality of holes or ducts 327 in the heater plate surface 325 for applying a vacuum and/or air pressure on the liner 319. The lower die 315 and/or the upper die 323, including the ducts 327 and/or the heater plate 325, could be otherwise shaped, arranged, positioned, and/or configured without departing from the disclosure. For example, the heater plate 325 could be omitted and the heat could be alternatively applied to the liner 319 (e.g., with a flow of hot air).

In the illustrated embodiment, the lower die 315 can hold the blanks 103, 203/folded blanks 103, 203 over the cavity 314 in the lower die 315 while supporting the lower blank 103/tray 105 at the flange panel 221 and/or the top end flaps 139, 143, 147, 151 (e.g., so that the flange panel 221 is facing upwardly). An initial vacuum can be applied to the ducts 327 to draw the liner 319 toward the upper die 323, the upper die 323 can be heated to a suitable temperature to soften the liner 319 and/or to activate a heat seal layer. Instead of, or in addition to, the initial vacuum, air pressure under the liner 319 can be employed with similar or equal effect. Subsequently, the liner 319 can be forced downwardly (e.g., by air pressure applied by the ducts 327 and/or a vacuum applied from below the lower blank 103/tray 105).

The air pressure can move the liner 319 toward the blank 103/tray 105 and the lower die 315 can support the blanks 103, 203/tray 105 as the liner 319 is applied to portions of one or more of the panels 121, 123, 127, 131, 135, 139, 143, 147, 151, 229, 233, 237, 241. In some embodiments, the liner 319 can additionally be applied to the flange panel 221.

In some embodiments, the liner 319 can help retain the tray 105 in its tray shape after the liner 319 is applied to the lower blank 103/folded blank 103/tray 105. For example, in some embodiments, the attachment of the liner 319 to the tray 105 can at least partially maintain the position of the side attachment panels 229, 233, 237, 241 in at least partial face-to-face contact with respective panels of the lower construct 111 of the tray 105.

In some embodiments, the tray 105 can be ejected from the lower die 315 and transported away from the forming tool on a conveyor, for example.

In one embodiment, the tray 105 can be formed from the lower blank 103 and have the liner 319 applied thereto at a much higher rate than systems that separately form the tray 105 from the blanks 103, 203 and then place that formed tray 105 into the lower die 315. In one example, the tray 105 of the present embodiment can be formed from the lower blank 103 together with the liner 319 at a rate of approximately 200 trays per minute. The tray 105 could be otherwise formed without departing from the disclosure. For example, the tray 105 could be formed from the blanks 103, 203 prior to applying the liner 319 (e.g., prior to engaging the lower die 315).

It will be understood that the tray 105/one or more portions thereof can have a different configuration without departing from the disclosure.

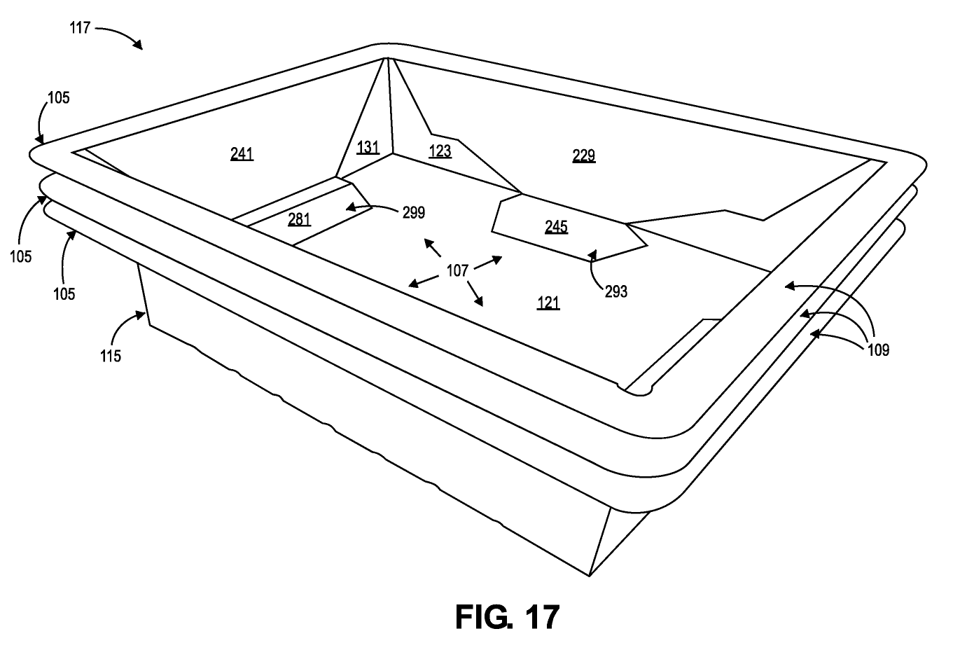

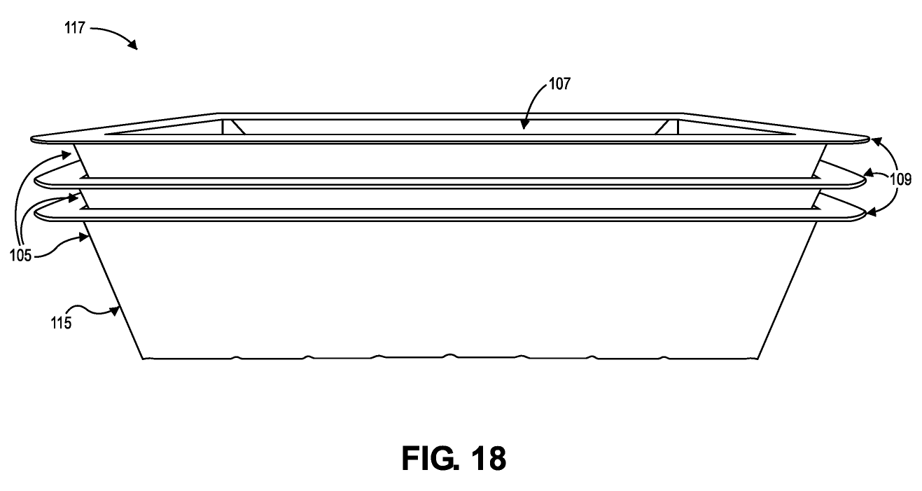

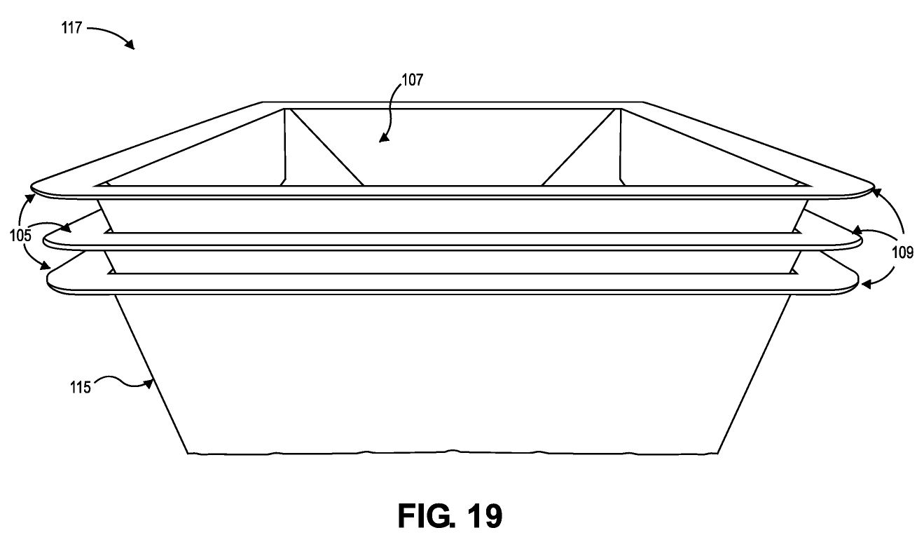

Turning to FIGS. 17-20, a tray 105 can be positioned at least partially receiving another tray 105 in the interior 107 thereof, e.g., in a stacked or nested arrangement. In some embodiments, a different configuration of tray or other container can be at least partially received in the interior 107 of the tray 105.

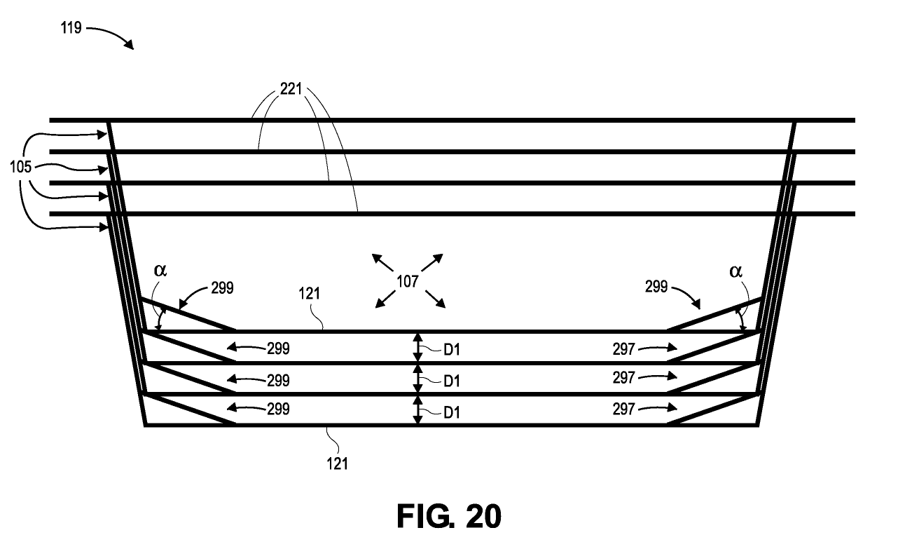

A stack 117 of three trays 105 is illustrated in FIGS. 17-19, and a stack 119 of four trays 105 is illustrated in FIG. 20. It will be understood that each tray 105 of the stacks 117, 119 can at least partially receive one of more upper vertically-adjacent trays 105 in the interior 107 thereof and/or can itself can be at least partially received in the interior 107 of a lower vertically-adjacent tray 105. It will be understood that other different stacked arrangements of trays can be provided without departing from the disclosure.

As shown in FIGS. 17-20, the denesting features 293, 295, 297, 299 can provide a suitable clearance between the bottom panel 121 of a given tray 105 in a stack and a vertically-adjacent tray 105 at least partially nested therein, e.g., to minimize, inhibit, prevent and/or avoid a close engagement of nested trays 105 that is unduly difficult for a user and/or machine process to separate with ease.

As shown in FIG. 20, the denesting features 293, 295, 297, 299 can be arranged to provide a desired vertical spacing D1 between the respective bottom panels 121 of nested trays 105. In some embodiments, the desired vertical spacing D1 can be between and including about 5.0mm and about 6.0mm, e.g., between and including about 5.1mm and about 5.9mm, between and including about 5.2mm and about 5.8mm, between and including about 5.3mm and about 5.7mm, between and including about 5.4mm and about 5.6mm, between and including about 5.5mm and about 5.5mm, etc. In some embodiments, D1 can be about 5.4mm.

In some embodiments, such arrangement of the denesting features 293, 295, 297, 299 can be at least partially provided via the arrangement of a respective denesting flap 245, 257, 269, 281 relative to the bottom panel 121 at an angle α. In some embodiments, the angle α can be between and including about 10° and about 30°, e.g., between and including about 11° and about 29°, between and including about 12° and about 28°, between and including about 13° and about 27°, between and including about 14° and about 26°, between and including about 15° and about 25°, between and including about 16° and about 24°, between and including about 17° and about 23°, between and including about 18° and about 22°, between and including about 19° and about 21°, etc.

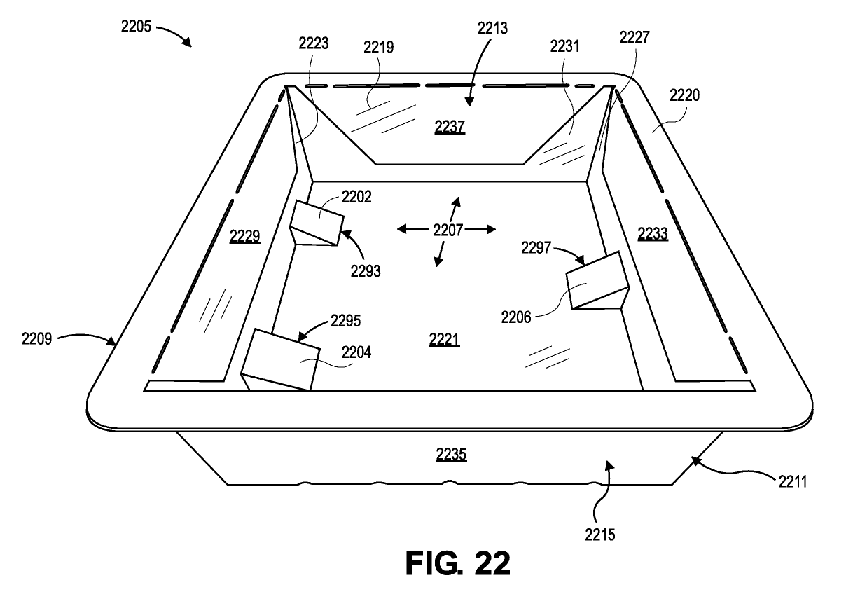

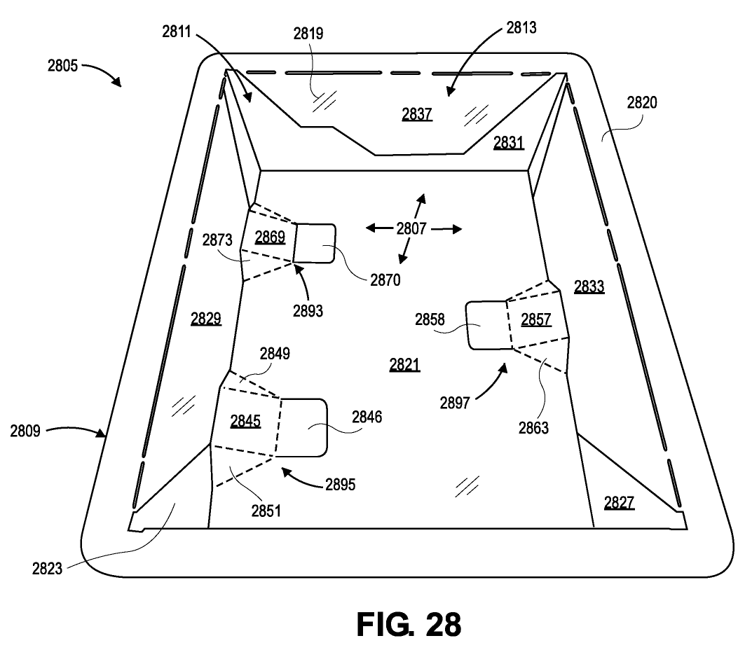

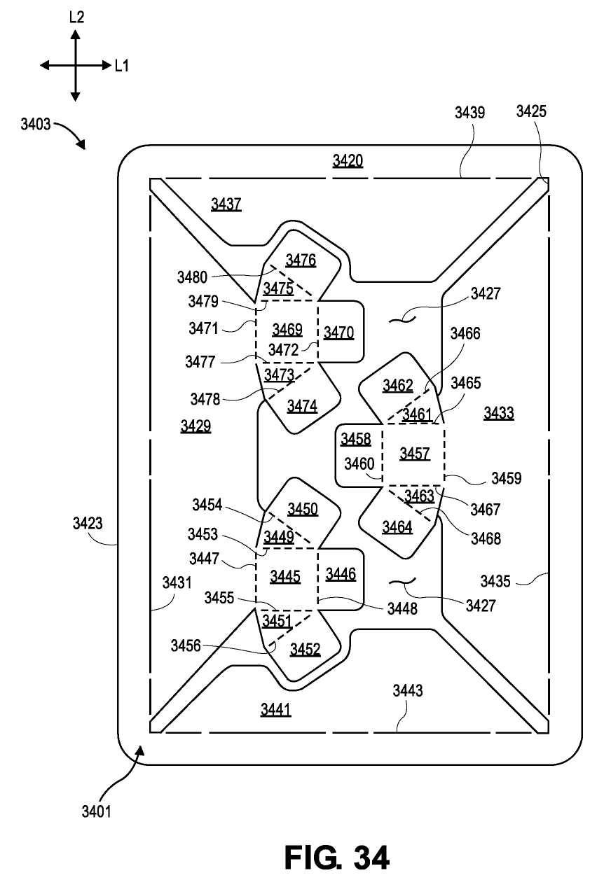

FIGS. 22-27 describe a second tray embodiment, FIGS. 28-33 describe a third tray embodiment and FIG. 34 is associated with a fourth tray embodiment. It should be understood that any feature described in connection with one embodiment may be applicable to other embodiments described herein. The embodiments described herein may be combined in any suitable manner, and features from different embodiments may be interchanged or combined to form additional embodiments within the scope of the present disclosure.

FIG. 22 illustrates a tray 2205 configured for holding one or more products according to a second embodiment. The tray 2205 that may be formed from an upper construct 2213 and a lower construct 2211. The tray 2205 may include an interior 2207 at least partially defined by a sidewall 2215 extending upwardly from a bottom panel 2221. The lower construct 2211 may form the primary structural framework of the tray 2205, providing a base and sidewall structure necessary for product containment. The upper construct 2213 may include a flange panel 2220 extending around the perimeter of the tray 2205 and may provide additional structural reinforcement and sealing capabilities.

The sidewall 2215 may be at least partially formed by a plurality of lower side panels that extend at least partially around the interior 2207 of the tray 2205. These lower side panels may include a front panel 2235, a back panel 2231, a first side panel 2223, and a second side panel 2227. Each of these lower side panels may be connected to the bottom panel 2221 through fold lines that enable the transformation from a flat blank configuration to the erected tray structure. The front panel 2235 and back panel 2231 may extend in the lateral direction, while the first side panel 2223 and second side panel 2227 may extend in the longitudinal direction to complete a sidewall perimeter.

The tray 2205 may include multiple attachment panels that facilitate the connection between the upper construct 2213 and the lower construct 2211. These attachment panels may include a first side attachment panel 2229, a second side attachment panel 2233, and a back attachment panel 2237. Each attachment panel may be configured to fold downwardly from the flange panel 2220 and engage with corresponding surfaces of the lower construct 2211 to provide a secure mechanical connection between the two constructs.

A plurality of denesting features may be formed in the lower construct 2211 and may extend upwardly into the interior 2207 of the tray. These denesting features may include a first denesting feature 2297 formed by a first ramp panel 2206, a second denesting feature 2293 formed by a second ramp panel 2202, and a third denesting feature 2295 formed by a third ramp panel 2204. Each ramp panel may extend upwardly from the bottom panel 2221 at an oblique angle to provide controlled spacing when multiple trays are nested together. The ramp panels may be positioned at strategic locations within the interior to ensure uniform support and spacing of nested trays while minimizing interference with product placement.

The second ramp panel 2202 and the third ramp panel 2204 may be longitudinally offset from the first ramp panel 2206, meaning that the second and third ramp panels 2202, 2204 may be positioned at a different location along the longitudinal direction of the tray 2205 compared to the first ramp panel 2206. This longitudinal offset may provide improved distribution of denesting support across the length of the tray and may prevent interference between the ramp panels during folding and assembly operations.

As shown in FIG. 22, a polymer-based liner 2219 may provide a continuous surface that spans across multiple interior surfaces of the tray 2205, including portions of the bottom panel 2221, the sidewall 2215, and the denesting features. The liner 2219 may adhere the free edges of the ramp panels 2202, 2204, 2206 to the sidewall 2215, providing additional structural support and preventing the ramp panels from shifting during use.

The liner 2219 may be formed from various materials including paper, plastic film, foil, or composite materials that provide the desired barrier properties, appearance, and adhesion characteristics. The liner 2219 may be applied during the assembly process after the lower construct 2211 has been erected and the ramp panels have been folded into their operative positions. The adhesive properties of the liner 2219 may eliminate the need for separate fasteners or adhesives to secure the ramp panel free edges, simplifying the assembly process while ensuring that the denesting features maintain their proper positioning throughout the life of the tray 2205. The liner 2219 may also provide enhanced product protection, moisture resistance, or improved appearance compared to the unlined tray configuration.

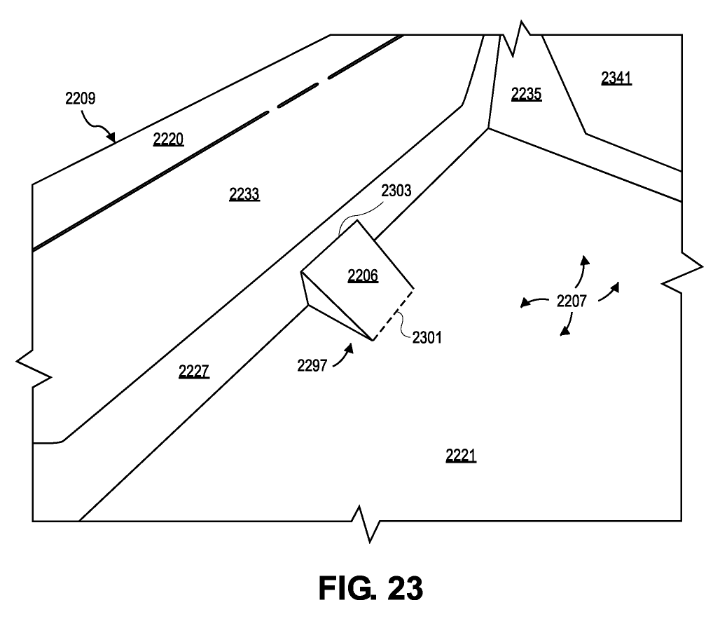

FIG. 23 illustrates an exploded perspective view of a portion of the tray 2205 showing the detailed relationship between the bottom panel 2221, the second side panel 2227 and the first denesting feature 2297. The first ramp panel 2206 of the first denesting feature 2297 may extend upwardly from the bottom panel 2221 along a longitudinal fold line 2301 that enables the first ramp panel 2206 to be folded from the flat blank configuration into its operative position within the interior 2207 of the tray 2205.

The first ramp panel 2206 may include a first free edge 2303 that may be positioned to contact the second side panel 2227 or to be adjacent/proximate the second side panel. As described further herein, the liner may hold first ramp panel 2206 in position with regard to second side panel 2227. The first ramp free edge 2303 may be positioned at a predetermined distance from the bottom panel 2221 to establish a vertical spacing between nested trays. The angle and positioning of the first ramp panel 2206 may be configured to provide sufficient support for the nested tray above while allowing easy separation during denesting operations.

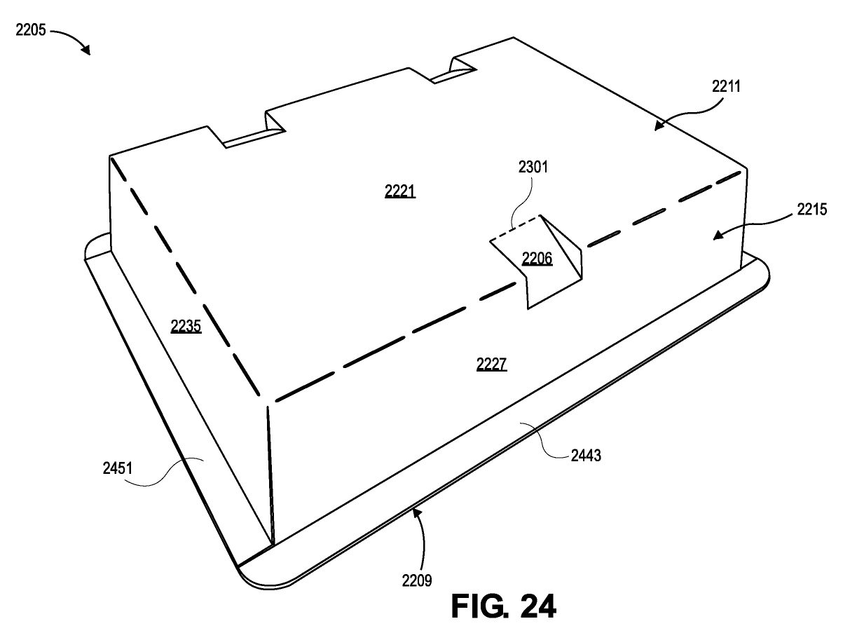

FIG. 24 illustrates a perspective bottom view of the tray 2205 from FIG. 22, showing a bottom surface of the bottom panel 2221 and the configuration of the lower construct 2211 from underneath. The bottom panel 2221 may form the base of the tray and may be visible from the bottom perspective, revealing the fold lines and panel arrangements that enable the formation of the sidewall structure. The flange 2209 may be visible extending outwardly from the upper edges of the sidewall panels, demonstrating how the flange structure appears when viewed from below the assembled tray. Top end flaps 2443 and 2451 of the lower construct 2211 may be visible as part of the flange formation, showing how these flaps contribute to the continuous flange surface around the perimeter of the tray.

From this bottom view, the first ramp panel 2206 may be visible through its connection to the bottom panel 2221 along a longitudinal fold line 2301, though the first ramp panel 2206 itself extends upwardly into the interior of the tray. The bottom view may reveal the structural arrangement of the lower construct 2211 and demonstrate how the various panels and fold lines work together to create the three-dimensional tray structure while maintaining the integrity of the denesting features formed by the ramp panels within the tray interior.

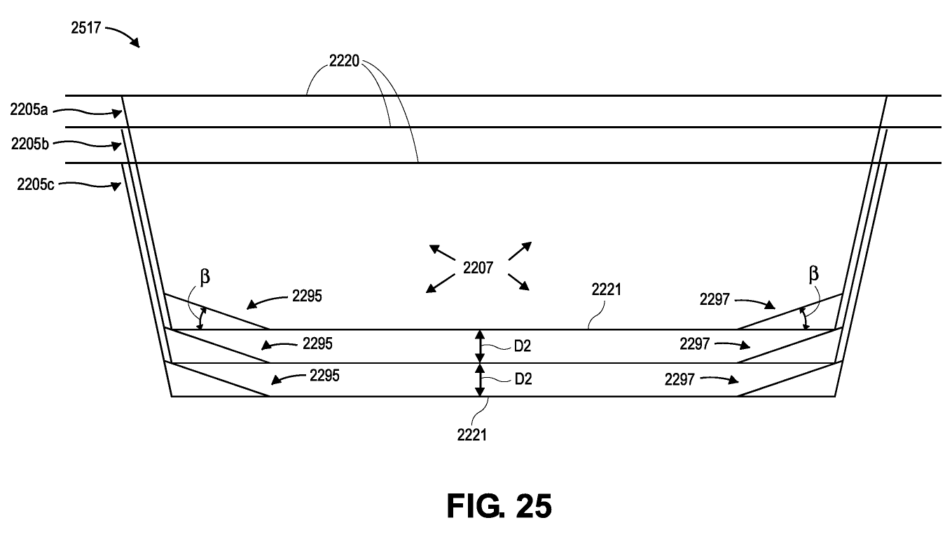

FIG. 25 illustrates a stack 2517 of trays 2205 according to the second embodiment. The stack 2517 may include a first tray 2205a, a second tray 2205b, and a third tray 2205c. The third tray 2205c may be positioned at the bottom of the stack 2517, the second tray 2205b may be positioned above the third tray 2205c, and the first tray 2205a may be positioned at the top of the stack 2517. Each tray may include the flange panel 2220, the interior 2207, and the bottom panel 2221 as described with reference to FIG. 22.

The denesting features (such as, the second denesting feature 2295 and the first denesting feature 2297) may maintain a controlled vertical spacing D2 between adjacent trays in the stack 2517. The denesting features may prevent the trays from nesting too deeply into one another, thereby facilitating separation of the trays from the stack 2517. FIG. 25 illustrates an angle β formed between the ramp panels and the bottom panel 2221. The angle β may be configured to provide the vertical spacing D2 while allowing easy separation of the nested trays.

This spacing D2 may be consistent throughout the stack 2517, ensuring uniform separation characteristics and facilitating automated handling operations. The stack 2517 configuration may provide efficient storage and transportation of multiple trays while maintaining the ability to easily separate individual trays when needed for filling or other operations.

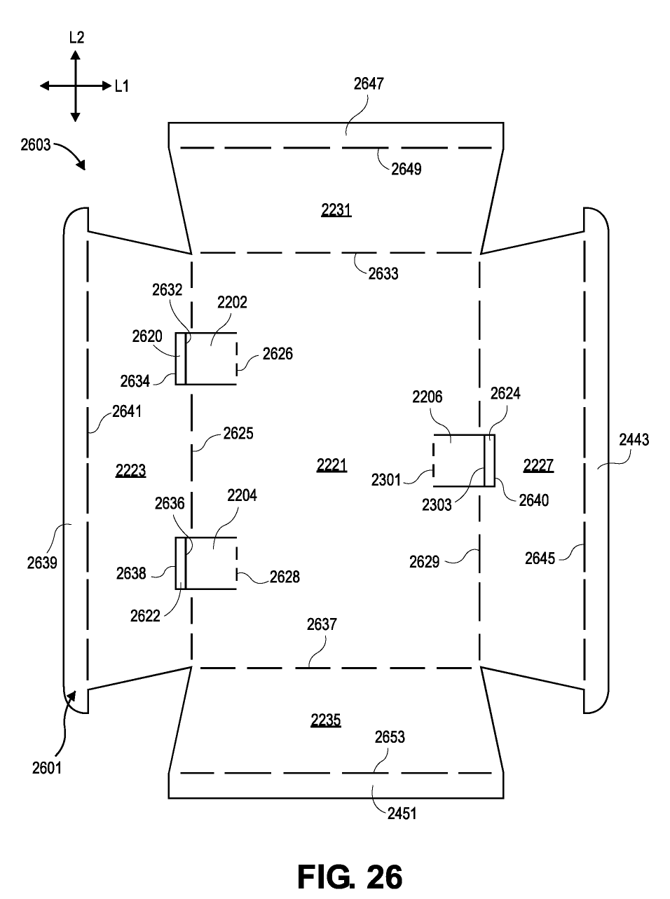

FIG. 26 illustrates a lower blank 2603 for forming the lower construct 2211 of the tray 2205 shown in FIG. 22, showing the flat configuration before assembly and the various panels and fold lines that enable the formation of the three-dimensional tray structure. As shown in FIG. 26, the lower blank 2603 may be oriented with a lateral direction L1 and a longitudinal direction L2 that define the primary axes of the lower blank 2603 and the resulting tray 2205. The lower blank 2603 may include an exterior surface 2601 that may face outwardly when the tray is assembled, and may include printing, coatings, or other surface treatments as needed for the specific application.

The lower blank 2603 may include the bottom panel 2221 that forms the base of the assembled tray 2205 and provides the foundation for the sidewall panels. The front panel 2235 and back panel 2231 may extend longitudinally from opposite edges of the bottom panel 2221, with these panels being connected to the bottom panel 2221 through respective lateral fold lines 2637, 2633 that enable the panels to be folded upwardly during assembly. Similarly, the first side panel 2223 and second side panel 2227 may extend laterally from opposite edges of the bottom panel, with these panels being connected through respective longitudinal fold lines 2625, 2629 that enable upward folding to complete the sidewall structure.

The denesting features may be formed by multiple ramp panels that are integrally connected to the bottom panel 2221 through fold lines. The first ramp panel 2206 may be connected to the bottom panel 2221 along longitudinal fold line 2301 and may include a first free edge 2303 that defines the extent of the first ramp panel 2206. The second ramp panel 2202 may be connected to the bottom panel 2221 along longitudinal fold line 2626 and may include a second free edge 2632. The third ramp panel 2204 may be connected to the bottom panel 2221 along longitudinal fold line 2628 and may include a third free edge 2636. Each ramp panel may be positioned at a strategic location within the bottom panel 2221 to provide optimal denesting performance when folded into its operative position. The ramp panels may interrupt respective longitudinal fold lines 2625, 2629.

Multiple cutouts 2620, 2622, 2624 may be provided in the blank to facilitate folding and assembly of the ramp panels and to prevent interference between adjacent panels during the folding process. These cutouts 2620, 2622, 2624 may be positioned to allow the ramp panels to fold upwardly and be adjacent to/proximate to the side panel without binding against adjacent material while maintaining the structural integrity of the blank. In some embodiments, the cutouts 2620, 2622, 2624 may also reduce material usage and provide cost savings in the manufacturing process.

Top end flaps 2443, 2451, 2639, 2647 may extend from various panels to help form a 2-ply flange structure when the tray 2205 is assembled. These top end flaps may be positioned at the upper edges of the sidewall panels and may be configured to fold outwardly to create the flange surface that extends around the perimeter of the assembled tray. The top end flaps may include fold lines, adhesive areas, or other features that enable their integration into the flange structure.

The blank may include numerous fold lines that enable the transformation from the flat configuration to the assembled tray. Longitudinal cuts 2634, 2638, 2640 may separate some adjacent panels and/or help define the cutouts 2620, 2622, 2624. Lateral fold lines 2633, 2637, 2649, 2653 may enable folding in the lateral direction, while longitudinal fold lines 2625, 2629, 2641, 2645 may enable folding in the longitudinal direction. The arrangement and orientation of these fold lines may be optimized to provide proper folding sequence, structural integrity, and ease of assembly while maintaining the desired tray configuration and denesting functionality.

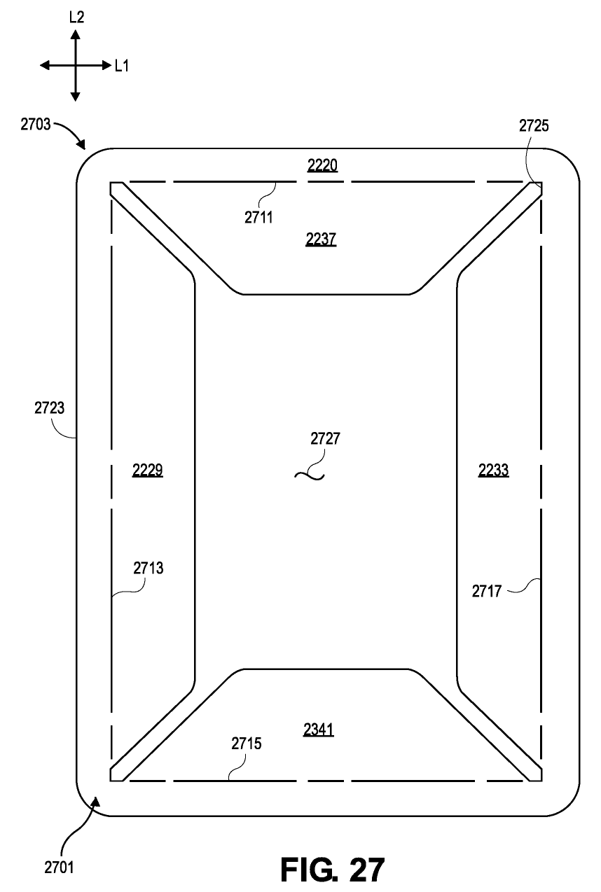

FIG. 27 illustrates an upper blank 2703 for forming the upper construct 2213 of the tray 2205 shown in FIG. 22, showing the configuration that enables the formation of the flange 2209 and attachment features that connect the upper construct 2213 to the lower construct 2211. The upper blank 2703 may be oriented with the lateral direction L1 and longitudinal direction L2 corresponding to the same directional references used for the lower blank 2603, ensuring proper alignment during assembly. The upper blank 2703 may include an exterior surface 2701 that may face outwardly when assembled and may include surface treatments, printing, or coatings as required for the specific application.

The upper blank 2703 may include a flange panel 2220 with an outer free edge 2723 and an inner edge 2725 that at least partially defines a central opening 2727. The flange panel 2220 may extend around at least part of a perimeter of the central opening 2727 and may provide a sealing surface for the assembled tray. The outer free edge 2723 may define the outermost boundary of the flange panel 2220, while the inner edge 2725 may at least partially define the boundary of the central opening 2727 through which products may be placed into or removed from the tray 2205.

Multiple attachment panels may extend inwardly from the inner edge 2725 of the flange panel 2220 into the central opening 2727. These attachment panels may include a front attachment panel 2341, a back attachment panel 2237, a first side attachment panel 2229, and a second side attachment panel 2233. Each attachment panel may be configured to fold downwardly from the plane of the flange panel 2220 and engage with corresponding surfaces of the lower construct 2211 during assembly. The attachment panels may provide mechanical connection between the upper construct 2213 and the lower construct 2211 through folding, adhesive bonding, mechanical interlocking, or other attachment methods.

The front attachment panel 2341 may be positioned to align with and attach to the front panel 2235 of the lower construct 2211, while the back attachment panel 2237 may be positioned to align with the back panel 2231. Similarly, the first side attachment panel 2229 and second side attachment panel 2233 may be positioned to align with the corresponding side panels of the lower construct 2211. This arrangement may ensure proper alignment and secure attachment between the two constructs while maintaining the structural integrity of the assembled tray 2205.

The upper blank 2703 may include multiple fold lines that enable the proper folding and assembly of the upper construct. Lateral fold lines 2711 and 2715 may enable folding in the lateral direction and may be positioned to allow the attachment panels to fold downwardly from the flange panel 2220. Longitudinal fold lines 2713 and 2717 may enable folding in the longitudinal direction and may provide the hinge points necessary for proper attachment panel positioning. The arrangement of these fold lines may be coordinated with the fold lines of the lower blank 2603 to ensure compatibility during assembly.

The upper blank 2703 configuration may enable the formation of the reinforced sidewall structure and flange sealing surface while maintaining compatibility with the denesting features formed by the lower construct. When assembled, the upper construct 2213 may not interfere with the operation of the ramp panels or the denesting functionality, while providing additional structural support and sealing capabilities to the overall tray assembly. The attachment panels may be sized and positioned to provide secure connection without creating interference with product placement or removal from the assembled tray.

FIG. 28 illustrates a tray 2805 according to a third embodiment that differs from other embodiments by including bottom tabs (e.g.. bottom tabs 2870, 2846, 2858) that are foldably connected to respective denesting flaps (e.g., denesting flaps 2869, 2845, 2857) and positioned in face-to-face contact with a bottom panel 2821 of a lower construct 2811. As shown in FIG. 28, the tray 2805 may include an upper construct 2813 and the lower construct 2811 with an interior 2807 defined by a sidewall 2815 extending upwardly from a bottom panel 2821. Similar to the first embodiment, the denesting features may be formed as part of the upper construct 2813 and may include denesting flaps and denesting tabs, but the third embodiment additionally includes a first bottom tab 2806, a second bottom tab 2802, and a third bottom tab 2804 that are foldably connected to the respective denesting flaps and positioned in face-to-face contact with the bottom panel 2821. These bottom tabs may reinforce the structural connection between the upper construct 2813 and the lower construct 2811, providing enhanced stability.

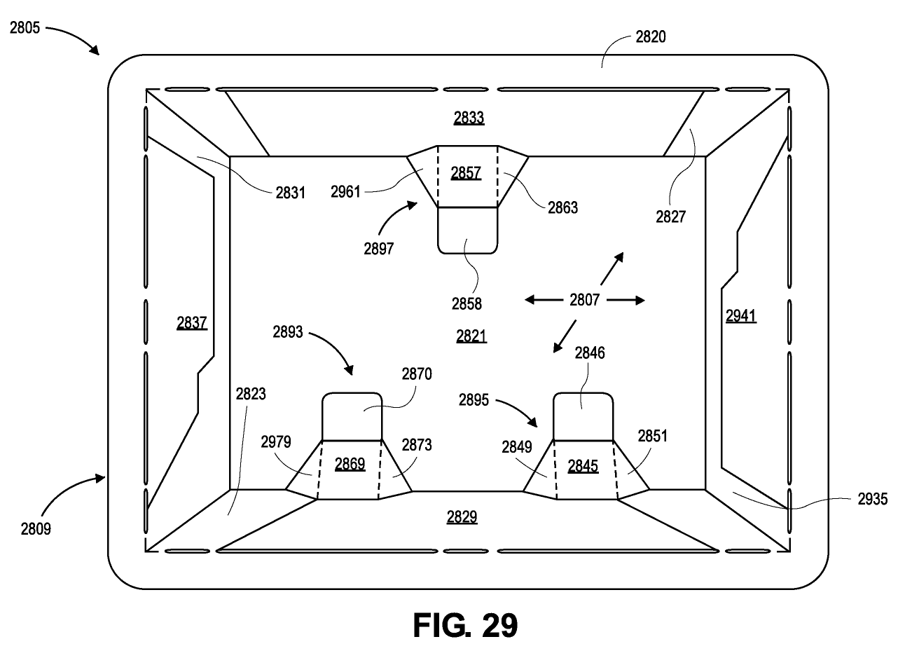

FIG. 29 illustrates a top view of the tray 2805 showing the relationship between the denesting flaps, denesting tabs, and the bottom tabs of the denesting features in the third embodiment. For example, a first denesting feature 2897 includes a first bottom tab 2858 that may be foldably connected to a first denesting flap 2857 and positioned in face-to-face contact with the bottom panel 2821, creating a reinforced connection between the upper construct 2813 and the lower construct 2811. The first denesting feature 2897 may be formed by the combination of the angled first denesting flap 2857, the angled denesting tabs 2863, 2961, and the flat first bottom tab 2858, with the first bottom tab 2858 providing enhanced resistance to deformation and improved structural integrity during stacking and handling operations.

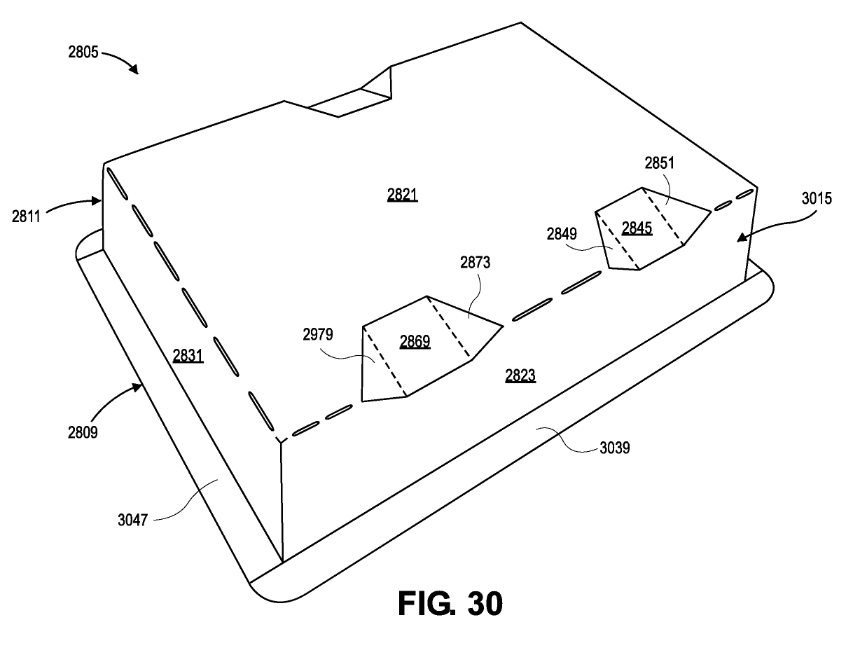

FIG. 30 illustrates a perspective bottom view of the tray 2805 from the third embodiment. The bottom panel 2821 may form the base of the tray 2805 and may be visible from the bottom perspective, with the bottom tabs positioned in face-to-face contact against the interior surface of the bottom panel 2821. Denesting flaps (e.g., second denesting flap 2869 and third denesting flap 2845) and denesting tabs of the denesting features may be visible through openings formed in the lower construct 2811.

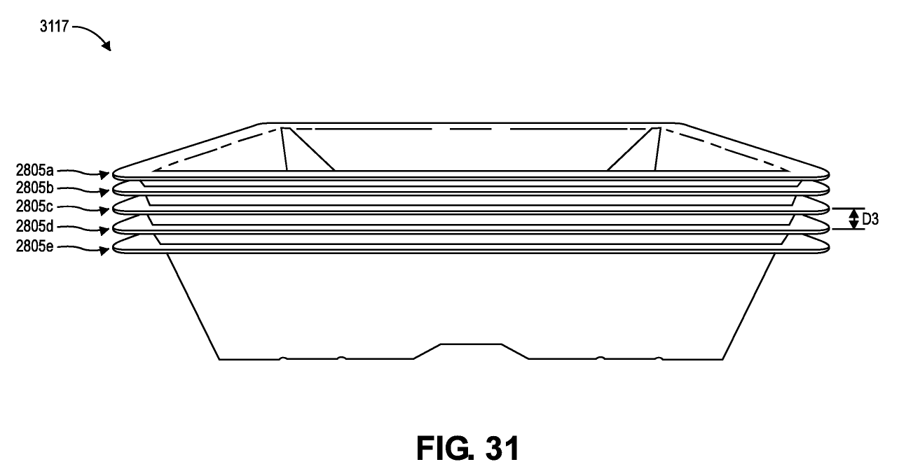

FIG. 31 illustrates a stack 3117 of trays according to the third embodiment, demonstrating how the reinforced denesting features with bottom tabs function during nesting operations. The stack 3117 may include a first tray 2805a, a second tray 2805b, a third tray 2805c. a fourth tray 2805d, and, a fifth tray 2805e arranged in a nested configuration, with each tray including the denesting features formed as part of the upper construct 2813 similar to the first embodiment. The controlled vertical spacing D3 between adjacent trays may be maintained by the denesting flaps and denesting tabs, while the bottom tabs that are in face-to-face contact with the bottom panels provide enhanced structural stability compared to the first embodiment. This reinforced configuration may reduce flexing or deformation of the denesting features during stacking operations, potentially providing more consistent spacing and improved stack stability.

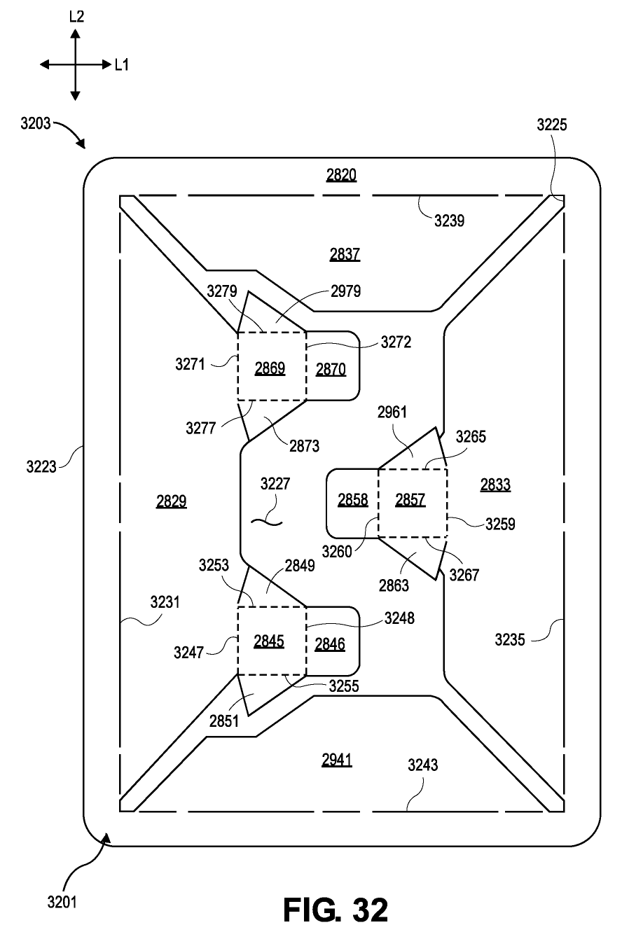

FIG. 32 illustrates an upper blank 3203 for forming the upper construct 2813 of the third embodiment tray 2805, which differs from the first embodiment upper blank by including bottom tabs that are foldably connected to the denesting flaps. As shown in FIG. 32, the upper blank 3203 may be oriented with the lateral direction L1 and longitudinal direction L2 and may include an exterior surface 3201. The upper blank 3203 may include a central flange panel 2820 with attachment panels extending inwardly, including a front attachment panel 2941, back attachment panel 2837, first side attachment panel 2829, and second side attachment panel 2833, similar to previous embodiments. The key difference in the third embodiment is the inclusion of bottom tabs that are foldably connected to the denesting flaps and configured to fold horizontally relative to the angled denesting flaps to achieve face-to-face contact with the bottom panel 2821 of the lower construct 2811, providing enhanced structural reinforcement compared to the first embodiment where the denesting features rely solely on sidewall attachment.

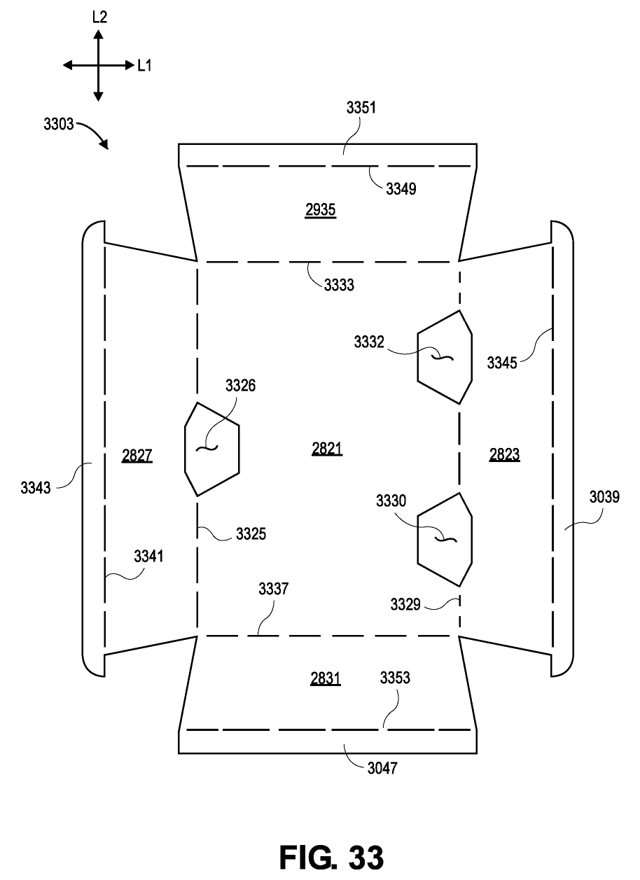

FIG. 33 illustrates a lower blank 3303 for forming the lower construct 2811 of the third embodiment tray 2805. The lower blank 3303 may include a central bottom panel 2821 with a front panel 2935, back panel 2831, first side panel 2823, and second side panel 2827 extending therefrom, similar to the first embodiment configuration. A difference in the third embodiment is that the bottom panel 2821 may be configured to receive and support the bottom tabs that extend from the denesting flaps of the upper construct, providing face-to-face contact surfaces that enhance the structural connection between the upper and lower constructs. Additionally, the lower blank 3303 may include openings (e.g., first opening 3326, second opening 3330, and third opening 3332) that may receive at least a portion of the denesting features of the upper construct 2813 when the tray 2805 is formed from the combination of the upper blank of FIG. 32 and the lower blank 3303 of FIG. 23. The openings may interrupt longitudinal fold lines 3325, 3329 that foldably connect respective side panels to the bottom panel 2821.

FIG. 34 illustrates an upper blank 3403 for forming an upper construct of a fourth embodiment tray that expands upon the third embodiment by including additional bottom tabs foldably connected to denesting tabs in addition to bottom tabs foldably connected to denesting flaps. As shown in FIG. 34, the upper blank 3403 may be oriented with the lateral direction L1 and longitudinal direction L2 and may include an exterior surface 3401. The upper blank 3403 may include a central flange panel 3420 with attachment panels extending inwardly, similar to previous embodiments, but differs from the third embodiment by providing bottom tabs foldably connected to both the denesting flaps and the denesting tabs, allowing all of the bottom tabs to be positioned in face-to-face contact with the bottom panel when assembled. For example, a first denesting flap 3457 may be foldably connected to a first bottom tab 3458 and to a first denesting tab 3461 and a second denesting tab 3463. The first denesting tab may be foldably connected to a second bottom flap 3462 and the second denesting tab 3463 may be foldably connected to a third bottom tab 3464. This configuration may provide enhanced structural reinforcement compared to the third embodiment by supporting both the denesting flaps and denesting tabs through direct contact with the bottom panel of the lower construct. The upper blank 3403 may be compatible with the lower blank 3303 of FIG. 33, enabling the formation of a fourth embodiment tray with maximum structural stability through comprehensive bottom tab reinforcement of all denesting features.

In some embodiments, when alternating trays in a stack are rotated 180 degrees relative to adjacent trays, the denesting features (e.g., ramp panels) may dictate the stacking gap between the flanges of adjacent trays. In some embodiments where the trays are all stacked in the same orientation, the denesting features (e.g., ramp panels) may similarly dictate the stacking gap between the flanges of adjacent trays as compared to embodiments that don’t have the denesting features where the draft angle of the tray sidewalls may dictate the gap between flanges and may vary based on the tray’s position in the stack. More specifically, in embodiments where the draft angle of the tray sidewall dictates the gap, the gap may change due to the increased weight of the trays above. Therefore, the denesting ramp panels may be used to provide a consistent gap throughout the stack height, regardless of the position of the trays in the stack and regardless of the orientation of the trays in the stack.

It will be understood that one or more portions of the trays described herein can be differently configured without departing from the disclosure.

Any of the features of the various embodiments of the disclosure can be combined with, replaced by, or otherwise configured with other features of other embodiments of the disclosure without departing from the scope of this disclosure.

Optionally, one or more portions of the blank or other constructs described herein or contemplated hereby may be coated with varnish, clay, or other materials, either alone or in combination. The coating may then be printed over with product advertising or other information or images. The blanks or other constructs also may be selectively coated and/or printed so that less than the entire surface area of the blank or substantially the entire surface area of the blank may be coated and/or printed.

Any of the blanks, trays, or other constructs of this disclosure may optionally include one or more features that alter the effect of microwave energy during the heating or cooking of a food item that is associated with the tray or other construct. For example, the blank, tray, container, or other construct may be formed at least partially from one or more microwave energy interactive elements (hereinafter sometimes referred to as “microwave interactive elements”) that promote heating, browning and/or crisping of a particular area of the food item, shield a particular area of the food item from microwave energy to prevent overcooking thereof, or transmit microwave energy towards or away from a particular area of the food item. Each microwave interactive element comprises one or more microwave energy interactive materials or segments arranged in a particular configuration to absorb microwave energy, transmit microwave energy, reflect microwave energy, or direct microwave energy, as needed or desired for a particular construct and food item.

In the case of a susceptor or shield, the microwave energy interactive material may comprise an electroconductive or semiconductive material, for example, a vacuum deposited metal or metal alloy, or a metallic ink, an organic ink, an inorganic ink, a metallic paste, an organic paste, an inorganic paste, or any combination thereof. Examples of metals and metal alloys that may be suitable include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof.

Alternatively, the microwave energy interactive material may comprise a metal oxide, for example, oxides of aluminum, iron, and tin, optionally used in conjunction with an electrically conductive material. Another metal oxide that may be suitable is indium tin oxide (ITO). ITO has a more uniform crystal structure and, therefore, is clear at most coating thicknesses.

Alternatively, still, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

In other embodiments, the microwave energy interactive material may be carbon-based, for example, as disclosed in U.S. Patent Nos. 4,943,456, 5,002,826, 5,118,747, and 5,410,135.

In still other embodiments, the microwave energy interactive material may interact with the magnetic portion of the electromagnetic energy in the microwave oven. Correctly chosen materials of this type can self-limit based on the loss of interaction when the Curie temperature of the material is reached. An example of such an interactive coating is described in U.S. Patent No. 4,283,427.

The use of other microwave energy interactive elements is also contemplated. In one example, the microwave energy interactive element may comprise a foil or high optical density evaporated material having a thickness sufficient to reflect a substantial portion of impinging microwave energy. Such elements typically are formed from a conductive, reflective metal or metal alloy, for example, aluminum, copper, or stainless steel, in the form of a solid “patch” generally having a thickness of from about 0.000285 inches to about 0.005 inches, for example, from about 0.0003 inches to about 0.003 inches. Other such elements may have a thickness of from about 0.00035 inches to about 0.002 inches, for example, 0.0016 inches.

In some cases, microwave energy reflecting (or reflective) elements may be used as shielding elements where the food item is prone to scorching or drying out during heating. In other cases, smaller microwave energy reflecting elements may be used to diffuse or lessen the intensity of microwave energy. One example of a material utilizing such microwave energy reflecting elements is commercially available from Graphic Packaging International, Inc. (Atlanta, GA) under the trade name MicroRite® packaging material. In other examples, a plurality of microwave energy reflecting elements may be arranged to form a microwave energy distributing element to direct microwave energy to specific areas of the food item. If desired, the loops may be of a length that causes microwave energy to resonate, thereby enhancing the distribution effect. Microwave energy distributing elements are described in U.S. Patent Nos. 6,204,492, 6,433,322, 6,552,315, and 6,677,563, each of which is incorporated by reference in its entirety.

If desired, any of the numerous microwave energy interactive elements described herein or contemplated hereby may be substantially continuous, that is, without substantial breaks or interruptions, or may be discontinuous, for example, by including one or more breaks or apertures that transmit microwave energy. The breaks or apertures may extend through the entire structure, or only through one or more layers. The number, shape, size, and positioning of such breaks or apertures may vary for a particular application depending on the type of construct being formed, the food item to be heated therein or thereon, the desired degree of heating, browning, and/or crisping, whether direct exposure to microwave energy is needed or desired to attain uniform heating of the food item, the need for regulating the change in temperature of the food item through direct heating, and whether and to what extent there is a need for venting.

By way of illustration, a microwave energy interactive element may include one or more transparent areas to effect dielectric heating of the food item. However, where the microwave energy interactive element comprises a susceptor, such apertures decrease the total microwave energy interactive area, and therefore, decrease the amount of microwave energy interactive material available for heating, browning, and/or crisping the surface of the food item. Thus, the relative amounts of microwave energy interactive areas and microwave energy transparent areas may be balanced to attain the desired overall heating characteristics for the particular food item.

As another example, one or more portions of a susceptor may be designed to be microwave energy inactive to ensure that the microwave energy is focused efficiently on the areas to be heated, browned, and/or crisped, rather than being lost to portions of the food item not intended to be browned and/or crisped or to the heating environment. Additionally, or alternatively, it may be beneficial to create one or more discontinuities or inactive regions to prevent overheating or charring of the food item and/or the construct including the susceptor.

As still another example, a susceptor may incorporate one or more “fuse” elements that limit the propagation of cracks in the susceptor, and thereby control overheating, in areas of the susceptor where heat transfer to the food is low and the susceptor might tend to become too hot. The size and shape of the fuses may be varied as needed. Examples of susceptors including such fuses are provided, for example, in U.S. Patent No. 5,412,187, U.S. Patent No. 5,530,231, U.S. Patent Application Publication No. US 2008/0035634A1, published Feb. 14, 2008, and PCT Application Publication No. WO 2007/127371, published Nov. 8, 2007, each of which is incorporated by reference herein in its entirety.

Any of the features of the various embodiments of the disclosure can be combined with, replaced by, or otherwise configured with other features of other embodiments of the disclosure without departing from the scope of this disclosure. Further, it is noted that the nesting arrangements and/or the features of the blanks and cartons of the various embodiments can be incorporated into a container or blank having any container style or panel configuration. The container styles and panel configurations described above are included by way of example.

The blanks according to any of the embodiments of the present disclosure can be, for example, formed from coated paperboard and similar materials. For example, the interior and/or exterior sides of the blank can be coated with a clay coating. The clay coating may then be printed over with product, advertising, price coding, and other information or images. The blank may then be coated with a varnish to protect any information printed on the blank. The blank may also be coated with, for example, a moisture barrier layer, on either or both sides of the blank. In accordance with the above-described embodiments, the blank may be constructed of paperboard of a caliper such that it is heavier and more rigid than ordinary paper. The blank can also be constructed of other materials, such as cardboard, hard paper, or any other material having properties suitable for enabling the carton to function at least generally as described herein. The blank can also be laminated or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type of tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various embodiments. Various additions, modifications, changes, etc., could be made to the embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A tray for holding one or more products, the tray comprising:
an upper construct comprising:
a first plurality of panels comprising a flange panel and a plurality of upper side panels extending from the flange panel;
a lower construct comprising:
a second plurality of panels comprising a bottom panel and a plurality of lower side panels forming a sidewall extending at least partially around an interior of the tray; and
a plurality of denesting features formed in the lower construct and extending in the interior of the tray.

2. The tray of claim 1, wherein the plurality of lower side panels includes a front panel, a back panel, a first side panel, and a second side panel.

3. The tray of claim 2, wherein the plurality of denesting features includes a ramp panel foldably connected to the bottom panel at a ramp fold line.

4. The tray of claim 3, wherein the ramp panel includes a free edge opposite the ramp fold line.

5. The tray of claim 4, wherein the free edge is at the sidewall.

6. The tray of claim 5, further comprising a liner adhered to the ramp panel and the sidewall.

7. The tray of claim 3, wherein the ramp panel is a first ramp panel, the ramp fold line is a first ramp fold line, and the plurality of denesting features further includes a second ramp panel foldably connected to the bottom panel at a second ramp fold line.

8. The tray of claim 7, wherein the second ramp panel is longitudinally offset from the first ramp panel.

9. The tray of claim 7, wherein the plurality of denesting features further includes a third ramp panel foldably connected to the bottom panel at a third ramp fold line.

10. A combination of blanks for forming a tray for holding one or more products, the combination of blanks comprising:
an upper blank for forming an upper construct, the upper blank comprising a first plurality of panels comprising a flange panel and a plurality of upper side panels extending from the flange panel;
a lower blank for forming a lower construct, the lower blank comprising a second plurality of panels comprising a bottom panel and a plurality of lower side panels for forming a sidewall extending at least partially around an interior of the tray when the tray is formed from the combination of blanks; and
a plurality of denesting features formed in the lower blank and extending in the interior of the tray when the tray is formed from the combination of blanks.

11. The combination of blanks of claim 10, wherein the plurality of lower side panels includes a front panel, a back panel, a first side panel, and a second side panel.

12. The combination of blanks of claim 11, wherein the plurality of denesting features includes a ramp panel foldably connected to the bottom panel at a ramp fold line.

13. The combination of blanks of claim 12, wherein the ramp panel includes a free edge opposite the ramp fold line.

14. The combination of blanks of claim 13, wherein the free edge is at the sidewall when the tray is formed from the combination of blanks.

15. The combination of blanks of claim 14, further comprising a liner configured to be adhered to the ramp panel and the sidewall when the tray is formed from the combination of blanks.

16. The combination of blanks of claim 12, wherein the ramp panel is a first ramp panel, the ramp fold line is a first ramp fold line, and the plurality of denesting features further includes a second ramp panel foldably connected to the bottom panel at a second ramp fold line.

17. The combination of blanks of claim 16, wherein the second ramp panel is longitudinally offset from the first ramp panel.

18. The combination of blanks of claim 16, wherein the plurality of denesting features further includes a third ramp panel foldably connected to the bottom panel at a third ramp fold line.

19. A method of forming a tray for holding one or more products, the method comprising:
forming an upper construct from an upper blank, the upper construct comprising a first plurality of panels comprising a flange panel and a plurality of upper side panels extending from the flange panel; and
forming a lower construct from a lower blank, the lower construct comprising a second plurality of panels comprising a bottom panel and a plurality of lower side panels forming a sidewall extending at least partially around an interior of the tray; and
forming a plurality of denesting features in the lower construct and extending in the interior of the tray.

20. The method of claim 19, wherein the plurality of lower side panels includes a front panel, a back panel, a first side panel, and a second side panel.

21. The method of claim 20, wherein the plurality of denesting features includes a ramp panel foldably connected to the bottom panel at a ramp fold line.

22. The method of claim 21, wherein the ramp panel includes a free edge opposite the ramp fold line.

23. The method of claim 22, wherein the free edge is at the sidewall.

24. The method of claim 23, further comprising adhering a liner to the ramp panel and the sidewall.

25. The method of claim 21, wherein the ramp panel is a first ramp panel, the ramp fold line is a first ramp fold line, and the plurality of denesting features further includes a second ramp panel foldably connected to the bottom panel at a second ramp fold line.

26. The method of claim 25, wherein the second ramp panel is longitudinally offset from the first ramp panel.

27. The method of claim 25, wherein the plurality of denesting features further includes a third ramp panel foldably connected to the bottom panel at a third ramp fold line.
